(19) United States
(12) Patent Application Publication
(10) Pub. No.: US 2023/0232837 A1
(43) Pub. Date: Jul. 27, 2023

(54) NOVEL FORMULATIONS FOR INCREASING THE GERMINATION RATE OF FUNGAL SPORES

(71) Applicant: DANSTAR FERMENT AG, Zug (CH)

(72) Inventors: Arite Wolf, Schwaan (DE); Hadi Shamsijazeyi, St. Louis, MO (US)

(73) Assignee: DANSTAR FERMENT AG, Zug (CH)

(21) Appl. No.: 18/000,923

(22) PCT Filed: Jun. 8, 2021
(86) PCT No.: PCT/EP2021/065222

§ 371 Date: Dec. 6, 2022

(30) Foreign Application Priority Data
Jun. 8, 2020 (EP) 20178750.4

(51) Int. Cl. A01N 63/38; A01N 25/22; A01N 57/12; A01N 25/02

(52) U.S. Cl. CPC A01N 63/38; A01N 25/22; A01N 57/12; A01N 25/02

(57) ABSTRACT

The present invention relates to a preparation for stabilizing fungal spores. The formulation comprises at least one glycerophospholipid and spores of a fungal microorganism.

Biological control agents (BCAs) become more and more important in the area of plant protection, be it for combatting various fungal or insect pests or for improving plant health. Although also viruses are available which can be used as biological control agents, mainly BCAs based on bacteria and fungi are used in this area. The most prominent form of biological control agents based on fungi are the asexual spores called conidia as well as blastospores, but also other fungal propagules may be promising agents, such as (micro)sclerotia, ascospores, basidiospores, chlamydospores or hyphal fragments.

Unlike many spores based on bacteria, such as Bacillus spores, many fungal spores are less robust and it has proven to be difficult to provide fungal spores in a form which meets the needs of commercial products, in particular an acceptable storage stability at certain conditions, e.g. temperatures.

The provision of suitable formulations for biological control agents, in particular fungal spores, thus still poses a challenge due to the many factors contributing to the efficacy of the final formulation such as nature of the biological control agent, temperature stability and shelf life as well as effects of the formulation in the application.

Suitable formulations are homogeneous and stable mixtures of active and inert ingredients which make the final product simpler, safer, and more efficacious to apply to a target.

Commonly used formulations for biological control agents include WP, a solid formulation micronized to powder form and typically applied as suspended particles after dispersion in water, and WG, a formulation consisting of granules to be applied after disintegration and dispersion in water. The granules of a WG product has distinct particles within the range 0.2 to 4 mm. Water dispersible granules can be formed by agglomeration, spray drying, or extrusion techniques. WP formulations are produced rather easily but they are dusty. Further, they are not easy to dose in the field. WG formulations are easier to handle for the user and in general have lower dust content than WP formulations.

An example for a liquid formulation is SC, a water-based suspension of solid active ingredient in a fluid usually intended for dilution with water before use. Another liquid formulation type is EC, a solution of active ingredient combined with surfactants like e. g. emulsifying agents in a water insoluble organic solvent which will form an emulsion when added to water.

An enormous number of formulants have been utilized in experimental and commercial formulations of biological control agents (for a more detailed description and list see Schisler et al., Phytopathology, Vol 94, No. 11, 2004). Generally, formulants can be grouped as either carriers (fillers, extenders) or formulants that improve the chemical, physical, physiological or nutritional properties of the formulated biomass. Stability, particularly storage stability of BCAs based on fungal actives over a longer period of time at temperatures at or above room temperature is a particular challenge due to the delicate nature of the fungal spores, most notably conidia. Like many living organisms, fungal conidia in their dormant state are sensible to environmental influences like e.g. water, air (oxygen), temperature, irradiation etc. Some factors may trigger germination while most others may have detrimental effects to the spore viability. In order to exclude water, oils like white mineral (paraffinic) oils or vegetable oils are typically used to prepare liquid fungal spore formulations. Many of these oils provide some but not sufficient shelf life for fungal organisms. Vegetable oils are of natural origin and are essentially mixed carboxylic acid triglycerides composed of glycerin and C12-C18 saturated and unsaturated fatty acids; they also contain varying amounts of natural waxes.

An example for a formulation of a biological control agent is described in Torres et al., 2003, J Appl Microbiol, 94(2), pp: 330-9). However, it is clear that a formulation preserving viability of the biological control agent, e. g. fungal spores, of more than 70% for 4 months at 4 degrees ° C. only is not suitable for everyday use in the field. Rather, it is desirable that formulations of biological control agents have a sufficient shelf life even under conditions where cold storage is not possible.

Kim et al., 2010 (J. S. Kim, Y. H. Je, J. Y. Roh, Journal of Industrial Microbiology & Biotechnology 2010, vol 37 (issue 4), pp, 419ff) disclose that conidia of the fungus Isaria fumosorosea show improved stability during a 2 and 8 hour heat treatment at 50° C. when dispersed in oils (Soybean, corn, cotton seed, paraffin oil, methyl oleate) in comparison to dispersion in water.

Mbarga et al., 2014 (Biological Control 2014, vol. 77, pp. 15ff) found that Trichoderma asperellum formulated in soybean oil with different emulsifiers shows improved shelf life in comparison to a dispersion of conidia in water.

With the disadvantages described above there is still the need for simple, easy to handle formulation recipes for biological control agents based on fungal actives. Among other properties, such formulations shall ideally exhibit a suitable shelf life over time, in particular at elevated temperatures (20° C. or greater), provide a good physical stability in the formulation concentrate, and provide good water miscibility or suspensibility.

This technical problem has at least in part been solved by the present invention.

Accordingly, in a first aspect, the present invention relates to a preparation comprising at least one glycerophospholipid and spores of a fungal microorganism.

The term “at least one” indicates that in any case one kind of substance such as a glycerophospholipid is present in a composition such as the preparation according to the invention. However, more than one such as (at least) two, (at least) three, (at least) four, (at least) 5 or even more different kinds of a substance such as glycerophospholipids may be present in a composition such as the preparation according to the invention.

Unless indicated otherwise, preferred embodiments described for one aspect of the invention also apply to other aspects of the invention.

Glycerophospholipids are derivatives of glycerophosphoric acid that contain at least one O-acyl, or O-alkyl, or O-alk-1′-enyl residue attached to a glycerol moiety. Glycerophospholipids comprise the structural groups of phosphatidylcholine, phosphatidylethanolamine, phosphatidylinositol, phosphatidylserine, phosphatidic acid which are also called lecithins. Accordingly, lecithin can be at least one such glycerophospholipid but also any mixture of glycerophospholipids belonging to any one of the foregoing groups.

With regard to the glycerophospholipid comprised in the composition according to the invention, it is preferred that such glycerophospholipids are present and/or added in isolated form and not as ingredient of oils such as vegetable oils. In other words, the composition according to the present invention preferably does not contain vegetable oils that comprise substantial amounts of glycerophosphoplipids.

In particular, the composition preferably does not contain soybean oil.

Spores of a fungal microorganism include sexually (e. g. oospores, zygospores or ascospores) and asexually (e. g. conidia and chlamydospores, but also uredospores, teleutospores and ustospores) formed spores. In connection with the present invention, also microsclerotia are considered spores. Preferably the spores are conidia.

Glycerophsopholipid(s) and spores of a fungal microorganism are preferably present in a weight ratio range of between 10:1 and 1:5000. Any ratio in between these ratios is possible in connection with the present invention. For example, a suitable ratio range includes between 8:1 and 1:100, 5:1 and 1:200, 5:1 and 1:100, 5:1 and 1:50, 5:1 and 1:20, 5:1 and 1:10. More preferably, the ratio range is between 2:1 and 1:200, or between 2:1 and 1:100, or between 2:1 and 1:50, or between 2:1 and 1:20 or more preferably between 2:1 and 1:10, such as 1:1, 1:2, 1:3, 1:4, 1:5, 1:6, 1:7, 1:8 and 1:9.

Lecithin of different sources may have different compositions of the components as listed above. For example, major components of soybean-derived lecithin are: 33-35% Soybean oil, 20-21% phosphatidylinositols, 19-21% phosphatidylcholine, 8-20% phosphatidylethanolamine, 5-11% other phosphatides, 5% free carbohydrates, 2-5% sterols and 1% moisture.

Among the lecithin products which can be used are those having CAS no. 8002-43-5, such as soybean lecithin form Beantown Chemicals.

As can be seen in the appended examples, the present inventors have surprisingly found that addition of glycerophospholipids, in particular lecithin, enhances the germination rate and thus the viability of fungal spores, beyond what has been achieved in the art. Furthermore, it is thought that the addition of lecithin to fungal spores after harvest and before drying. An additional advantage of the addition of lecithin to fungal spores which need to be wet-harvested is that this in addition facilitates the process of harvesting. In other words, for hydrophobic spores where wet-harvest (using water and some surfactants to wash the spores from the substrate and then subsequently removing that added water through different techniques including drying) may lead to higher harvest yields, lecithin can be used to increase the germination of such wet-harvested spores.

Any fungal species may be applied for the present invention. It is, however, preferred that said fungal spores are from a fungal species which has a beneficial effect on plant, such as a fungal species effective as biological control agent in plant protection or as plant health promoting agent. More preferably, said fungus is a filamentous fungus.

As used herein, “biological control” is defined as control of one or more pathogens or pests, in particular phytopathogenic micro-organisms, in the following also called phytopathogens, and/or insects and/or acarids and/or nematodes and/or mollusks and/or bacteria and/or rodents and/or weeds by the use of a second organism. Known mechanisms of biological control include endophytic bacteria and fungi that live in symbiosis with the plants and may cause a plant reaction toward pathogens, pests and stress or promote plant growth. Microorganisms can also act as biological control agents through their secondary metabolites. As an example, certain bacteria may control root rot by out-competing phytopathogenic fungi for space or nutrients on the surface of the root. Active ingredients from bacteria, such as antibiotics, have been used to control pathogens. The active ingredients can be isolated and applied directly to the plant or the bacterial species may be administered so it produces the active ingredient in situ. Other means of exerting biological control include the application of certain fungal microorganisms producing specific metabolites such as toxins, enzymes or plant hormones or attacking the target pest/pathogen directly. Again, further means of biological control include the application of fungi or certain fungal spores to the soil where the fungus itself invades e.g. insect pathogens such as nematodes.

Beneficial effects on plants include activity against insects (insecticide), acarids (acaricide), nematodes (nematicide), molluscs (molluscicide), bacteria (bactericide), weeds (herbicide) and/or phytopathogens (e. g. fungicide).

“Insecticides” as well as the term “insecticidal” refers to the ability of a substance to increase mortality or inhibit growth rate of insects. As used herein, the term “insects” includes all organisms in the class “Insecta”. The term “pre-adult insects” refers to any form of an organism prior to the adult stage, including, for example, eggs, larvae, and nymphs.

“Acaricide” as well as the term “acaricidal” refer to the ability of a substance to increase mortality or inhibit growth rate of acarides, e.g. ticks and mites.

“Nematicides” and “nematicidal” refers to the ability of a substance to increase mortality or inhibit the growth rate of nematodes. In general, the term “nematode” comprises eggs, larvae, juvenile and mature forms of said organism.

Fungal microorganisms active against phytopathogens such as phytopathogenic fungi are suitable to increase mortality or inhibit growth rate of phytopathogens such as phytopathogenic fungi or viruses.

Biological control agents active against molluscs are suitable to increase mortality or inhibit growth rate of molluscs such as snails and slugs.

Biological control agents active against weeds are suitable to increase mortality or inhibit growth rate of weeds.

Filamentous fungi, as the skilled person is well aware, are distinguished from yeasts because of their tendency to grow in a multicellular, filamentous form under most conditions, in contrast to the primarily unicellular growth of oval or elliptical yeast cells.

Said at least one filamentous fungus may be any fungus exerting a positive effect on plants such as a plant protective or plant growth promoting effect. Accordingly, said fungus may be an entomopathogenic fungus, a nematophagous fungus, a plant growth promoting fungus, a fungus active against plant pathogens such as bacteria or fungal plant pathogens, or a fungus with herbicidal action.

NRRL is the abbreviation for the Agricultural Research Service Culture Collection, an international depositary authority for the purposes of deposing microorganism strains under the Budapest treaty on the international recognition of the deposit of microorganisms for the purposes of patent procedure, having the address National Center for Agricultural Utilization Research, Agricultural Research service, U.S. Department of Agriculture, 1815 North university Street, Peroira, Ill. 61604 USA.

ATCC is the abbreviation for the American Type Culture Collection, an international depositary authority for the purposes of deposing microorganism strains under the Budapest treaty on the international recognition of the deposit of microorganisms for the purposes of patent procedure, having the address ATCC Patent Depository, 10801 University Blvd., Manassas, Va. 10110 USA.

Only few fungal microorganisms with selective herbicidal activity are known, such as F2.1 Phoma macrostroma, in particular strain 94-44B; F2.2 Sclerotinia minor, in particular strain IMI 344141 (e.g. Sarritor by Agrium Advanced Technologies); F2.3 Colletotrichum gloeosporioides, in particular strain ATCC 20358 (e.g. Collego (also known as LockDown) by Agricultural Research Initiatives); F2.4 Stagonospora atriplicis; or F2.5 Fusarium oxysporum, different strains of which are active against different plant species, e.g. the weed Striga hermonthica (Fusarium oxysproum formae specialis strigae).

Exemplary species of plant growth/plant health supporting, promoting or stimulating fungal microorganisms are E2.1 Talaromyces flavus, in particular strain V117b; E2.2 Trichoderma atroviride, in particular strain CNCM I-1237 (e.g. Esquive® WP from Agrauxine, FR), strain SC1 described in International Application No. PCT/IT2008/000196), strain no. V08/002387, strain no. NMI No. V08/002388, strain no. NMI No. V08/002389, strain no. NMI No. V08/002390, strain LC52 (e.g. Sentinel from Agrimm Technologies Limited), strain kd (e.g. T-Gro from Andermatt Biocontrol), and/or strain LUI32 (e.g. Tenet from Agrimm Technologies Limited); E2.3 Trichoderma harzianum, in particular strain ITEM 908 or T-22 (e.g. Trianum-P from Koppert); E2.4 Myrothecium verrucaria, in particular strain AARC-0255 (e.g. DiTera™ from Valent Biosciences); E2.5 Penicillium bilaii, in particular strain ATCC 22348 (e.g. JumpStart® from Acceleron BioAg), and/or strain ATCC20851; E2.6 Pythium oligandrum, in particular strains DV74 or M1 (ATCC 38472; e.g. Polyversum from Bioprepraty, CZ); E2.7 Rhizopogon amylopogon (e.g. comprised in Myco-Sol from Helena Chemical Company); E2.8 Rhizopogon fulvigleba (e.g. comprised in Myco-Sol from Helena Chemical Company); E2.9 Trichoderma harzianum, in particular strain TSTh20, strain KD, product Eco-T from Plant Health Products, ZA or strain 1295-22; E2.10 Trichoderma koningii; E2.11 Glomus aggregatum; E2.12 Glomus clarum; E2.13 Glomus deserticola; E2.14 Glomus etunicatum; E2.15 Glomus intraradices; E2.16 Glomus monosporum; E2.17 Glomus mosseae; E2.18 Laccaria bicolor; E2.19 Rhizopogon luteolus; E2.20 Rhizopogon tinctorus; E2.21 Rhizopogon villosulus; E2.22 Scleroderma cepa; E2.23 Suillus granulatus; E2.24 Suillus punctatapies; E2.25 Trichoderma virens, in particular strain GL-21; E2.26 Verticillium albo-atrum (formerly V. dahliae), in particular strain WCS850 (CBS 276.92; e.g. Dutch Trig from Tree Care Innovations); E2.27 Trichoderma viride, e.g. strain B35 (Pietr et al., 1993, Zesz. Nauk. A R w Szczecinie 161: 125-137) and E2.28 Purpureocillium lilacinum (previously known as Paecilomyces lilacinus) strain 251 (AGAL 89/030550; e.g. BioAct from Bayer CropScience Biologics GmbH).

In a more preferred embodiment, fungal microorganisms having a beneficial effect on plant health and/or growth are selected from Talaromyces flavus, strain VII7b; Trichoderma harzianum strain KD or strain in product Eco-T from Plant Health Products, SZ; Myrothecium verrucaria strain AARC-0255; Penicillium bilaii strain ATCC 22348; Pythium oligandrum strain DV74 or M1 (ATCC 38472); Trichoderma viride strain B35; Trichoderma atroviride strain CNCM I-1237, and Purpureocillium lilacinum (previously known as Paecilomyces lilacinus) strain 251 (AGAL 89/030550).

In an even more preferred embodiment, fungal microorganisms having a beneficial effect on plant health and/or growth are selected from Penicillium bilaii strain ATCC 22348, Trichoderma viride strain B35, Trichoderma atroviride strain CNCM I-1237 and Purpureocillium lilacinum (previously known as Paecilomyces lilacinus) strain 251 (AGAL 89/030550).

Bactericidally active fungal microorganisms are e.g.: A2.2 Aureobasidium pullulans, in particular blastospores of strain DSM14940; A2.3 Aureobasidium pullulans, in particular blastospores of strain DSM 14941 or mixtures of blastospores of strains DSM14940 and DSM14941; A2.9 Scleroderma citrinum.

Fungal microorganisms active against fungal pathogens are e.g. B2.1 Coniothyrium minitans, in particular strain CON/M/91-8 (Accession No. DSM-9660; e.g. Contans® from Bayer CropScience Biologics GmbH); B2.2 Metschnikowia fructicola, in particular strain NRRL Y-30752; B2.3 Microsphaeropsis ochrace, in particular strain P130A (ATCC deposit 74412); B2.4 Muscodor albus, in particular strain QST 20799 (Accession No. NRRL 30547); B2.5 Trichoderma harzianum rifai, in particular strain KRL-AG2 (also known as strain T-22, /ATCC 208479, e.g. PLANTSHIELD T-22G, Rootshield®, and TurfShield from BioWorks, US) and strain T39 (e.g. Trichodex® from Makhteshim, US); B2.6 Arthrobotrys dactyloides; B2.7 Arthrobotrys oligospora; B2.8 Arthrobotrys superba; B2.9 Aspergillus flavus, in particular strain NRRL 21882 (e.g. Afla-Guard® from Syngenta) or strain AF36 (e.g. AF36 from Arizona Cotton Research and Protection Council, US); B2.10 Gliocladium roseum (also known as Clonostachys rosea F. rosea), in particular strain 321U from Adjuvants Plus, strain ACM941 as disclosed in Xue (Efficacy of Clonostachys rosea strain ACM941 and fungicide seed treatments for controlling the root tot complex of field pea, Can Jour Plant Sci 83(3): 519-524), strain IK726 (Jensen D F, et al. Development of a biocontrol agent for plant disease control with special emphasis on the near commercial fungal antagonist Clonostachys rosea strain ‘IK726’; Australas Plant Pathol. 2007; 36:95-101), strain 88-710 (WO2007/107000), strain CR7 (WO2015/035504) or strains CRrO, CRM and CRr2 disclosed in WO2017109802; B2.11 Phlebiopsis (or Phlebia or Peniophora) gigantea, in particular strain VRA 1835 (ATCC 90304), strain VRA 1984 (DSM16201), strain VRA 1985 (DSM16202), strain VRA 1986 (DSM16203), strain FOC PG B20/5 (IM1390096), strain FOC PG SP log 6 (IM1390097), strain FOC PG SP log 5 (IM1390098), strain FOC PG BU3 (IM1390099), strain FOC PG BU4 (IM1390100), strain FOC PG 410.3 (IM1390101), strain FOC PG 97/1062/116/1.1 (IM1390102), strain FOC PG B22/SP1287/3.1 (IM1390103), strain FOC PG SH1 (IM1390104) and/or strain FOC PG B22/SP1190/3.2 (IM1390105) (Phlebiopsis products are e.g. Rotstop® from Verdera and FIN, PG-Agromaster®, PG-Fungler®, PG-IBL®, PG-Poszwald® and Rotex® from e-nema, DE); B2.12 Pythium oligandrum, in particular strain DV74 or M1 (ATCC 38472; e.g. Polyversum from Bioprepraty, CZ); B2.13 Scleroderma citrinum; B2.14 Talaromyces flavus, in particular strain V117b; B2.15 Trichoderma asperellum, in particular strain ICC 012 from Isagro or strain SKT-1 (e.g. ECO-HOPE® from Kumiai Chemical Industry), strain T34 (e.g. ASPERELLO® from Biobest Group NV and T34 BIOCONTROL® by Biocontrol Technologies S.L., ES); B2.16 Trichoderma atroviride, in particular strain CNCM 1-1237 (e.g. Esquive® WP from Agrauxine, FR), strain SCI described in International Application No. PCT/IT2008/000196), strain 77B (T77 from Andermatt Biocontrol), strain no. V08/002387, strain NMI no. V08/002388, strain NMI no. V08/002389, strain NMI no. V08/002390, strain LC52 (e.g. Sentinel from Agrimm Technologies Limited), strain LUI32 (e.g. Tenet by Agrimm Technologies Limited), strain ATCC 20476 (IMI 206040), strain T11 (IM1352941/CECT20498), strain SKT-1 (FERM P-16510), strain SKT-2 (FERM P-16511), strain SKT-3 (FERM P-17021); B2.17 Trichoderma harmatum; B2.18 Trichoderma harzianum, in particular, strain KD, strain T-22 (e.g. Trianum-P from Koppert), strain TH35 (e.g. Root-Pro by Mycontrol), strain DB 103 (e.g. T-Gro 7456 by Dagutat Biolab); B2.19 Trichoderma virens (also known as Gliocladium virens), in particular strain GL-21 (e.g. SoilGard by Certis, US); B2.20 Trichoderma viride, in particular strain TV1 (e.g. Trianum-P by Koppert), strain B35 (Pietr et al., 1993, Zesz. Nauk. A R w Szczecinie 161: 125-137); B2.21 Ampelomyces quisqualis, in particular strain AQ 10 (e.g. AQ 10® by CBC Europe, Italy); B2.22 Arkansas fungus 18, ARF; B2.23 Aureobasidium pullulans, in particular blastospores of strain DSM14940, blastospores of strain DSM 14941 or mixtures of blastospores of strains DSM14940 and DSM 14941 (e.g. Botector® by bio-ferm, CH); B2.24 Chaetomium cupreum (e.g. BIOKUPRUM™ by AgriLife); B2.25 Chaetomium globosum (e.g. Rivadiom by Rivale); B2.26 Cladosporium cladosporioides, in particular strain H39 (by Stichting Dienst Landbouwkundig Onderzoek); B2.27 Dactylaria candida; B2.28 Dilophosphora alopecuri (e.g. Twist Fungus); B2.29 Fusarium oxysporum, in particular strain Fo47 (e.g. Fusaclean by Natural Plant Protection); B2.30 Gliocladium catenulatum (Synonym: Clonostachys rosea F. catenulate), in particular strain J1446 (e.g. Prestop® by Lallemand); B2.31 Lecanicillium lecanii (formerly known as Verticillium lecanii), in particular conidia of strain KV01 (e.g. Vertalec® by Koppert/Arysta); B2.32 Penicillium vermiculatum; B2.33 Trichoderma gamsii (formerly T. viride), in particular strain ICC080 (IMI CC 392151 CABI, e.g. BioDerma by AGROBIOSOL DE MEXICO, S.A. DE C.V.); B2.34 Trichoderma polysporum, in particular strain IMI 206039 (e.g. Binab TF WP by BINAB Bio-Innovation AB, Sweden); B2.35 Trichoderma stromaticum (e.g. Tricovab by Ceplac, Brazil); B2.36 Tsukamurella paurometabola, in particular strain C-924 (e.g. HeberNem®); B2.37 Ulocladium oudemansii, in particular strain HRU3 (e.g. Botry-Zen® by Botry-Zen Ltd, NZ); B2.38 Verticillium albo-atrum (formerly V. dahliae), in particular strain WCS850 (CBS 276.92; e.g. Dutch Trig by Tree Care Innovations); B2.39 Muscodor roseus, in particular strain A3-5 (Accession No. NRRL 30548); B2.40 Verticillium chlamydosporium; B2.41 mixtures of Trichoderma asperellum strain ICC 012 and Trichoderma gamsii strain ICC 080 (product known as e.g. BIO-TAM™ from Bayer CropScience LP, US), B2.42 Simplicillium lanosoniveum and B2.43 Trichoderma fertile (e.g. product TrichoPlus from BASF).

In a preferred embodiment, the fungal microorganism having fungicidal activity is selected from Coniothyrium minitans, in particular strain CON/M/91-8 (Accession No. DSM-9660) Aspergillus flavus, strain NRRL 21882 (available as Afla-Guard® from Syngenta) and strain AF36 (available as AF36 from Arizona Cotton Research and Protection Council, US); Gliocladium roseum strain 321U, strain ACM941, strain IK726strain 88-710 (WO2007/107000), strain CR7 (WO2015/035504); Gliocladium catenulatum strain J1446; Phlebiopsis (or Phlebia or Peniophora) gigantea, in particular the strains VRA 1835 (ATCC 90304), VRA 1984 (DSM16201), VRA 1985 (DSM16202), VRA 1986 (DSM16203), FOC PG B20/5 (IMI390096), FOC PG SP log 6 (IMI390097), FOC PG SP log 5 (IMI390098), FOC PG BU3 (IMI390099), FOC PG BU4 (IMI390100), FOC PG 410.3 (IMI390101), FOC PG 97/1062/116/1.1 (IMI390102), FOC PG B22/SP1287/3.1 (IMI390103), FOC PG SH1 (IMI390104), FOC PG B22/SP1190/3.2 (IMI390105) (available as Rotstop® from Verdera and FIN, PG-Agromaster®, PG-Fungler®, PG-IBL®, PG-Poszwald®, and Rotex® from e-nema, DE); Pythium oligandrum, strain DV74 or M1 (ATCC 38472) (available as Polyversum from Bioprepraty, CZ); Talaromyces flavus, strain VII7b; Ampelomyces quisqualis, in particular strain AQ 10 (available as AQ 10® by CBC Europe, Italy); Gliocladium catenulatum (Synonym: Clonostachys rosea f. catenulate) strain J1446, Cladosporium cladosporioides, e. g. strain H39 (by Stichting Dienst Landbouwkundig Onderzoek), Trichoderma virens (also known as Gliocladium virens), in particular strain GL-21 (e.g. SoilGard by Certis, US), Trichoderma atroviride strain CNCM I-1237, strain 77B, strain LUI32 or strain SC1, having Accession No. CBS 122089, Trichoderma harzianum strain T-22 (e.g. Trianum-P from Andermatt Biocontrol or Koppert), Trichoderma asperellum strain SKT-1, having Accession No. FERM P-16510 or strain T34, Trichoderma viride strain B35 and Trichoderma asperelloides JM41R (Accession No. NRRL B-50759).

In a more preferred embodiment, the fungal microorganism having fungicidal activity is selected from Coniothyrium minitans, in particular strain CON/M/91-8 (Accession No. DSM-9660) (available as Contans® from Prophyta, DE); Gliocladium roseum strain 321U, strain ACM941, strain IK726; Gliocladium catenulatum, in particular strain J1446; and Trichoderma virens (also known as Gliocladium virens), in particular strain GL-21. Said fungal species may also preferably be Coniothyrium minitans strain CON/M/91-8 (Accession No. DSM-9660) or Gliocladium catenulatum strain J1446 or Trichoderma atroviride strain CNCM I-1237 or Trichoderma viride strain B35.

Within fungicidally active and/or plant growth promoting fungi, the genus Trichoderma spp., or their respective teleomorphs, Hypocrea spp. are preferred. Trichoderma strains appear to be very sensitive since the germination rate often quickly falls in liquid formulations. Many conventional and unconventional methods were tested in order to increase the germination rate of Trichoderma in liquid media; nevertheless, none truly succeeded. However, the novel composition and process claimed in this document shows clearly that under the conditions described, germination rate of the tested Trichoderma is significantly increased.

Preferably said fungal strains belong to the species Tichoderma atroviride, Trichoderma asperellum, Trichoderma harzianum, Trichoderma viride, Trichoderma virens Trichoderma koningii, Trichoderma hamatum, Trichoderma gamsii, Trichoderma stromaticum, Trichoderma fertile, Trichoderma longibrachiatum or Trichoderma polysporum. Exemplary strains, belonging to said species which are preferred are Trichoderma atroviride strain NMI no. V08/002387 (described in U.S. Pat. No. 8,394,623B2), strain NMI no. V08/002388, strain NMI no. V08/002389, strain NMI no. V08/002390, strain LC52 (e.g. Sentinel or Tenet from Agrimm Technologies Limited), strain CNCM I-1237 (e.g. Esquive from Agrauxine, France), strain SCI (e.g. Vintec from Bi-PA or Belchim, described in International Application No. PCT/IT2008/000196), strain B77 (e.g. T77 from Andermatt Biocontrol or Eco-77 from Plant Health Products), strain LUI32 (e.g. Tenet from Agrimm Technologies Limited), strain IMI 206040/ATCC 20476 (e.g. Binab TF WP from BINAB Bio-Innovation AB, Sweden), strain T11/IMI 352941/CECT 20498 (e.g. Tusal from Certis), strain SKT-1/FERM P-16510 (e.g. ECO-HOPE from Kumiai Chemical Industry Co), strain SKT-2/FERM P-16511, strain SKT-3/FERM P-17021, strain MUCL45632 (e.g. Tandem from Italpollina), strain WW10TC4/ATCC PTA 9707 (described in CA2751694A1), strain RR17Bc/ATCC PTA 9708, strain F11 Bab/ATCC PTA 9709; strain TF280 (described in CN107034146A), strain OB-1/KCCM 11173P (described in WO2012124863A1); Trichoderma harzianum strain KRL-AG2/ITEM 908/T-22/ATCC 20847 (e.g. Trianum-P from Koppert or PlantShield from BioWorks or Tricho D WP from Orius Biotecnologica), strain TH35 (e.g. Root-Pro from Mycontrol), strain T-39 (e.g. TRICHODEX and TRICHODERMA 2000 from Mycontrol), strain DB 103 (e.g. T-Gro 7456 from Dagutat Biolab, South Africa), strain DB 104 (e.g. Romulus from Dagutat Biolab, South Africa), strain TSTh20/ATCC PTA-10317 (described in Application EP2478090A1), strain ESALQ 1306 (e.g. Trichodermil from Koppert), Rifai strain KRL-AG2 (e.g. BW240 WP from BioWorks), strain T78 (e.g. OffYouGrow Tric from Microgaia Biotech), strain from Trichopel (Agrimm Technologies), strain RR17Bc/ATCC PTA 9708 (described in CA2751694A1), strain ThLm1/NRRL 50846 (described in US20150033420A1), strain IBLF 006 (e.g. Ecotrich WP and Predatox SC from Ballagro Agro Tecnologia Ltda., Brazil), strain DSM 14944 (e.g. Agroguard WG and Foliguard from Live Systems Technology SA, Colombia), strain 21 (e.g. Rootgard from Juanco SPS Ltd., Kenya), strain SF (e.g. Bio-Tricho from Agro-Organics, South Africa), strain IIHR-Th-2 (e.g. Ecosom-TH from Agri Life, India), strain MTCC5530 (described in US20120015806A1); Trichoderma virens (also known as Gliocladium virens) strain GL-21 (e.g. SoilGard by Certis, USA), strain G1-21, strain G1-3/ATCC 58678 (e.g. QuickRoots from Novozymes), strain DSM25764, strain G-41 (e.g. RootShieldPlus from BioWorks); Trichoderma viride strain TV1/MUCL 43093 (e.g. Virisan from Isagro), strain MTCC5532 (described in US20120015806A1), strain NRRL B-50520 (described in CN104203871A); Trichoderma polysporum strain IMI 206039/ATCC 20475/T-75 (e.g. Binab TF WP from BINAB Bio-Innovation AB, Sweden); Trichoderma stromaticum strain Ceplac 3550/ALF 64 (Tricovab from Ceplac, Brazil); Trichoderma asperellum strain kd (e.g. T-Gro from Andermatt Biocontrol or ECO-T from Plant Health Products), strain ICC 012/IMI 392716 (e.g. BIO-TAM and REMEDIER WP from Isagro Ricerca), strain B35 (Pietr et al., 1993, Zesz. Nauk. A R w Szczecinie 161: 125-137), strain BV10 (e.g. Tricho-Turbo from Biovalens), strain T34 (e.g. Asperello T34 Biocontrol from Biobest), strain T25/IMI 296237/CECT 20178 (e.g. Tusal from Certis), strain SKT-1 (e.g. Ecohope from Kumiai Chemical Industry Co.), strain URM 5911/SF04 (e.g. Quality WG from Laboratório de BioControle Farroupilha Ltda, Patos de Minas-MG, Brazil), strain H22 (e.g. TRICHOTECH WP from Dudutech); Trichoderma gamsii strain ICC 080 (e.g. BIO-TAM and REMEDIER WP from Isagro Ricerca), strain NRRL B-50520 (described in WO2017192117A1); Trichoderma koningii strain SC164; Trichoderma hamatum strain TH382/ATCC 20765 (e.g. Floragard from Sellew Associates); Trichoderma fertile strain JM41R (e.g. TrichoPlus from BASF); Trichoderma longibrachiatum strain Mk1/KV966 (described in WO2015126256A1). The species Trichoderma viride and Trichoderma atroviride, are especially preferred. Even more preferred strain of these species are Trichoderma atroviride strain CNCM I-1237 (e.g. Esquive® WP from Agrauxine, FR); Trichoderma atroviride strain SC1, having Accession No. CBS 122089, WO 2009/116106 and U.S. Pat. No. 8,431,120 (from Bi-PA); Trichoderma atroviride strain 77B (T77 from Andermatt Biocontrol); Trichoderma atroviride strain LUI32 (e.g. Sentinel from Agrimm Technologies Limited); Trichoderma asperellum strain B35 (Pietr et al., 1993, Zesz. Nauk. A R w Szczecinie 161: 125-137). Particularly preferred are Trichoderma atroviride strain CNCM I-1237 and Trichoderma viride strain B35 deposited under accession number DSM 33245.

In one embodiment, said fungal microorganism is an entomopathogenic fungus, i.e. a fungus with insecticidal activity.

Fungal microorganisms active against insects (entomopathogenic fungi) include C2.1 Muscodor albus, in particular strain QST 20799 (Accession No. NRRL 30547); C2.2 Muscodor roseus in particular strain A3-5 (Accession No. NRRL 30548); C2.3 Beauveria bassiana, in particular strain ATCC 74040 (e.g. Naturalis® from Intrachem Bio Italia); strain GHA (Accession No. ATCC74250; e.g. BotaniGuard Es and Mycotrol-O from Laverlam International Corporation); strain ATP02 (Accession No. DSM 24665); strain PPRI 5339 (e.g. BroadBand™ from BASF); strain PPRI 7315, strain R444 (e.g. Bb-Protec from Andermatt Biocontrol), strains IL197, IL12, IL236, IL10, IL131, IL 116 (all referenced in Jaronski, 2007. Use of Entomopathogenic Fungi in Biological Pest Management, 2007: ISBN: 978-81-308-0192-6), strain Bv025 (see e.g. Garcia et al. 2006. Manejo Integrado de Plagas y Agroecologia (Costa Rica) No. 77); strain BaGPK; strain ICPE 279, strain CG 716 (e.g. BoveMax® from Novozymes); C2.4 Hirsutella citriformis; C2.5 Hirsutella thompsonii (e.g. Mycohit and ABTEC from Agro Bio-tech Research Centre, IN); C2.6 Lecanicillium lecanii (formerly known as Verticillium lecanii), in particular conidia of strain KV01 (e.g. Mycotal® and Vertalec® from Koppert/Arysta), strain DAOM198499 or strain DAOM216596; C2.9 Lecanicillium muscarium (formerly Verticillium lecanii), in particular strain VE 6/CABI(=IMI) 268317/CBS102071/ARSEF5128 (e.g. Mycotal from Koppert); C2.10 Metarhizium anisopliae var acridum, e.g. ARSEF324 from GreenGuard by Becker Underwood, US or isolate IMI 330189 (ARSEF7486; e.g. Green Muscle by Biological Control Products); C2.11 Metarhizium brunneum, e.g. strain Cb 15 (e.g. ATTRACAP® from BIOCARE); C2.12 Metarhizium anisopliae, e.g. strain ESALQ 1037 (e.g. from Metarril® SP Organic), strain E-9 (e.g. from Metarril® SP Organic), strain M206077, strain C4-B (NRRL 30905), strain ESCl, strain 15013-1 (NRRL 67073), strain 3213-1 (NRRL 67074), strain C20091, strain C20092, strain F52 (DSM3884/ATCC 90448; e.g. BIO 1020 by Bayer CropScience and also e.g. Met52 by Novozymes) or strain ICIPE 78; C2.15 Metarhizium robertsii 23013-3 (NRRL 67075); C2.13 Nomuraea rileyi; C2.14 Paecilomyces fumosoroseus (new: Isaria fumosorosea), in particular strains Apopka 97 (available as PreFeRal from Certis, USA), Fe9901 (available as NoFly from Natural industries, USA), ARSEF 3581, ARSEF 3302, ARSEF 2679 (ARS Collection of Entomopathogenic Fungal Cultures, Ithaca, USA), IfB01 (China Center for Type Culture Collection CCTCC M2012400), ESALQ1296, ESALQ1364, ESALQ1409 (ESALQ: University of Sio Paulo (Piracicaba, SP, Brazil)), CG1228 (EMBRAPA Genetic Resources and Biotechnology (Brasilia, DF, Brazil)), KCH J2 (Dymarska et al., 2017; PLoS one 12(10)): e0184885), HIB-19, HIB-23, HIB-29, HIB-30 (Gandarilla-Pacheco et al., 2018; Rev Argent Microbiol 50: 81-89), CHE-CNRCB 304, EH-511/3 (Flores-Villegas et al., 2016; Parasites & Vectors 2016 9:176 doi: 10.1186/s13071-016-1453-1), CHE-CNRCB 303, CHE-CNRCB 305, CHE-CNRCB 307 (Gallou et al., 2016; fungal biology 120 (2016) 414-423), EH-506/3, EH-503/3, EH-520/3, PFCAM, MBP, PSMB1 (National Center for Biololgical Control, Mexico; Castellanos-Moguel et al., 2013; Revista Mexicana De Micologia 38: 23-33, 2013), RCEF3304 (Meng et al., 2015; Genet Mol Biol. 2015 July-September; 38(3): 381-389), PFO1-N10 (CCTCC No. M207088), CCM 8367 (Czech Collection of Microorganisms, Brno), SFP-198 (Kim et al., 2010; Wiley Online: DOI 10.1002/ps.2020), K3 (Yanagawa et al., 2015; J Chem Ecol. 2015; 41(12): 118-1126), CLO 55 (Ansari Ali et al., 2011; PLoS One. 2011; 6(1): e16108. DOI: 10.1371/journal.pone.0016108), IfITS01, IfTS02, IfITS07 (Dong et al. 2016/PLoS ONE 11(5): e0156087. doi:10.1371/journal.pone.0156087), P1 (Sun Agro Biotech Research Centre, India), If-02, If-2.3, If-03 (Farooq and Freed, 2016; DOI: 10.1016/j.bjm.2016.06.002), Ifr AsC (Meyer et al., 2008; J. Invertebr. Pathol. 99:96-102. 10.1016/j.jip.2008.03.007), PC-013 (DSMZ 26931), P43A, PCC (Carrillo-Pérez et al., 2012; DOI 10.1007/s11274-012-1184-1), Pf04, Pf59, Pfl09 (KimJun et al., 2013; Mycobiology 2013 December; 41(4): 221-224), FG340 (Han et al., 2014; DOI: 10.5941/MYCO.2014.42.4.385), Pfr1, Pfr8, Pfr9, Pfr10, Pfr11, Pfr12 (Angel-Sahagnn et al., 2005; Journal of Insect Science), Ifr531 (Daniel and Wyss, 2009; DOI 10.1111/j.1439-0418.2009.01410.x), IF-1106 (Insect Ecology and Biocontrol Laboratory, Shanxi Agricultural University), 19602, 17284 (Hussain et al. 2016, DOI:10.3390/ijms17091518), I03011 (U.S. Pat. No. 4,618,578), CNRCB1 (Centro Nacional de Referencia de Control Biologico (CNRCB), Colima, Mexico), SCAU-IFCFO1 (Nian et al., 2015; DOI: 10.1002/ps.3977), PFO1-N4 (Engineering Research Center of Biological Control, SCAU, Guangzhou, P. R. China) Pfr-612 (Institute of Biotechnology (IB—FCB-UANL), Mexico), Pf-Tim, Pf-Tiz, Pf-Hal, Pf-Tic (Chan-Cupul et al. 2013, DOI: 10.5897/AJMR12.493); C2.15 Aschersonia aleyrodis; C2.16 Beauveria brongniartii (e.g. Beaupro from Andermatt Biocontrol AG); C2.17 Conidiobolus obscurus; C2.18 Entomophthora virulenta (e.g. Vektor from Ecomic); C2.19 Lagenidium giganteum; C2.20 Metarhizium flavoviride; C2.21 Mucor haemelis (e.g. BioAvard from Indore Biotech Inputs & Research); C2.22 Pandora delphacis; C2.23 Sporothrix insectorum (e.g. Sporothrix Es from Biocerto, BR); and C2.24 Zoophtora radicans.

In a preferred embodiment, fungal microorganisms having an insecticidal effect are selected from C2.3 Beauveria bassiana strain ATCC 74040; strain GHA (Accession No. ATCC74250); strain ATP02 (Accession No. DSM 24665); strain PPRI 5339; strain PPRI 7315, strain R444, strains IL197, IL12, IL236, IL10, IL131, IL 116; strain BaGPK; strain ICPE 279, strain CG 716; C2.6 Lecanicillium lecanii (formerly known as Verticillium lecanii), in particular conidia of strain KV01, strain DAOM198499 or strain DAOM216596; C2.9 Lecanicillium muscarium (formerly Verticillium lecanii) strain VE 6/CABI(=IMI) 268317/CBS102071/ARSEF5128; C2.10 Metarhizium anisopliae var acridum strain ARSEF324 or isolate IMI 330189 (ARSEF7486); C2.11 Metarhizium brunneum strain Cb 15; C2.12 Metarhizium anisopliae strain ESALQ 1037, strain E-9, strain M206077, strain C4-B (NRRL 30905), strain ESCl, strain 15013-1 (NRRL 67073), strain 3213-1 (NRRL 67074), strain C20091, strain C20092, strain F52 (DSM3884/ATCC 90448) or strain ICIPE 78; C2.14 Paecilomyces fumosoroseus (new: Isaria fumosorosea) strain Apopka 97, Fe9901, ARSEF 3581, ARSEF 3302, ARSEF 2679, IfB01 (China Center for Type Culture Collection CCTCC M2012400), ESALQ1296, ESALQ1364, ESALQ1409, CG1228, KCH J2, HIB-19, HIB-23, HIB-29, HIB-30, CHE-CNRCB 304, EH-511/3, CHE-CNRCB 303, CHE-CNRCB 305, CHE-CNRCB 307, EH-506/3, EH-503/3, EH-520/3, PFCAM, MBP, PSMB1, RCEF3304, PFO1-N10 (CCTCC No. M207088), CCM 8367, SFP-198, K3, CLO 55, IfTS01, IfTS02, IfTS07, P1, If-02, If-2.3, If-03, Ifr AsC, PC-013 (DSMZ 26931), P43A, PCC, Pf04, Pf59, Pfl09, FG340, Pfr1, Pfr8, Pfr9, Pfr10, Pfr11, Pfr12, Ifr531, IF-1106, I9602, I7284, I03011 (U.S. Pat. No. 4,618,578), CNRCB1, SCAU-IFCFO1, PFO1-N4, Pfr-612, Pf-Tim, Pf-Tiz, Pf-Hal and Pf-Tic.; and C2.16 Beauveria brongniartii (e.g. Beaupro from Andermatt Biocontrol AG).

In a more preferred embodiment, fungal microorganisms having an insecticidal effect are selected from C2.3 Beauveria bassiana strain ATCC 74040; strain GHA (Accession No. ATCC74250); strain ATP02 (Accession No. DSM 24665); strain PPRI 5339; strain PPRI 7315 and/or strain R444; C2.6 Lecanicillium lecanii (formerly known as Verticillium lecanii), conidia of strain KV01, strain DAOM198499 or strain DAOM216596; C2.9 Lecanicillium muscarium (formerly Verticillium lecanii), in particular strain VE 6/CABI(=IMI) 268317/CBS102071/ARSEF5128; C2.10 Metarhizium anisopliae var acridum strain ARSEF324 or isolate IMI 330189 (ARSEF7486); C2.11 Metarhizium brunneum strain Cb 15; C2.12 Metarhizium anisopliae strain strain F52 (DSM3884/ATCC 90448); C2.14 Paecilomyces fumosoroseus (new: Isaria fumosorosea) strain Apopka 97 and Fe9901, and C2.16 Beauveria brongniartii (e.g. Beaupro from Andermatt Biocontrol AG).

It is even more preferred that said fungal microorganism is a strain of the species Isaria fumosorosea. Preferred strains of Isaria fumosorosea are selected from the group consisting of Apopka 97, Fe9901, ARSEF 3581, ARSEF 3302, ARSEF 2679, IfB01 (China Center for Type Culture Collection CCTCC M2012400), ESALQ1296, ESALQ1364, ESALQ1409, CG1228, KCH J2, HIB-19, HIB-23, HIB-29, HIB-30, CHE-CNRCB 304, EH-511/3, CHE-CNRCB 303, CHE-CNRCB 305, CHE-CNRCB 307, EH-506/3, EH-503/3, EH-520/3, PFCAM, MBP, PSMB1, RCEF3304, PFO1-N10 (CCTCC No. M207088), CCM 8367, SFP-198, K3, CLO 55, IfTS01, IfTS02, IfTS07, P1, If-02, If-2.3, If-03, Ifr AsC, PC-013 (DSMZ 26931), P43A, PCC, Pf04, Pf59, Pfl09, FG340, Pfr1, Pfr8, Pfr9, Pfr10, Pfr11, Pfr12, Ifr531, IF-1106, I9602, I7284, I03011 (U.S. Pat. No. 4,618,578), CNRCB1, SCAU-IFCFO1, PFO1-N4, Pfr-612, Pf-Tim, Pf-Tiz, Pf-Hal, Pf-Tic.

It is most preferred that said Isaria fumosorosea strain is selected from Apopka 97 and Fe9901. A particularly preferred strain is APOPKA97.

Also particularly preferred are entomopathogenic fungi of the genus Metarhizium spp. The genus Metahrizium comprises several species some of which have recently been re-classified (for an overview, see Bischoff et al., 2009; Mycologia 101 (4): 512-530). Members of the genus Metarhizium comprise M. pingshaense, M. anisopliae, M. robertsii, M. brunneum (these four are also referred to as Metarhizium anisopliae complex), M. acridum, M. majus, M. guizouense, M. Lepidiotae, M. Globosum and M. rileyi (previously known as Nomuraea rileyi). Of these, M. anisopliae, M. robertsii, M. brunneum, M. acridum and M. rileyi are even more preferred, whereas those of M. brunneum are most preferred.

Exemplary strains belonging to Metarhizium spp. which are also especially preferred are Metarhizium acridum ARSEF324 (product GreenGuard by BASF) or isolate IMI 330189 (ARSEF7486; e.g. Green Muscle by Biological Control Products); Metarhizium brunneum strain Cb 15 (e.g. ATTRACAP® from BIOCARE), or strain F52 (DSM3884/ATCC 90448; e.g. BIO 1020 by Bayer CropScience and also e.g. Met52 by Novozymes); Metarhizium anisopliae complex strains strain ESALQ 1037 or strain ESALQ E-9 (both from Metarril® WP Organic), strain M206077, strain C4-B (NRRL 30905), strain ESCl, strain 15013-1 (NRRL 67073), strain 3213-1 (NRRL 67074), strain C20091, strain C20092, or strain ICIPE 78. Most preferred are isolate F52 (a.k.a. Met52) which primarily infects beetle larvae and which was originally developed for control of Otiorhynchus sulcatus. and ARSEF324 which is commercially used in locust control. Commercial products based on the F52 isolate are subcultures of the individual isolate F52 and are represented in several culture collections including: Julius Kuhn-Institute for Biological Control (previously the BBA), Darmstadt, Germany: [as M.a. 43]; HRI, UK: [275-86 (acronyms V275 or KVL 275)]; KVL Denmark [KVL 99-112 (Ma 275 or V 275)]; Bayer, Germany [DSM 3884]; ATCC, USA [ATCC 90448]; USDA, Ithaca, USA [ARSEF 1095]. Granular and emulsifiable concentrate formulations based on this isolate have been developed by several companies and registered in the EU and North America (US and Canada) for use against black vine weevil in nursery ornamentals and soft fruit, other Coleoptera, western flower thrips in greenhouse ornamentals and chinch bugs in turf.

Beauveria bassiana is mass-produced and used to manage a wide variety of insect pests including whiteflies, thrips, aphids and weevils. Preferred strains of Beauveria bassiana include strain ATCC 74040; strain GHA (Accession No. ATCC74250); strain ATP02 (Accession No. DSM 24665); strain PPRI 5339; strain PPRI 7315, strains IL197, IL12, IL236, IL10, IL131, IL116, strain Bv025; strain BaGPK; strain ICPE 279, strain CG 716; ESALQPL63, ESALQ447 and ESALQ1432, CG1229, IMI389521, NPP111B005, Bb-147. It is most preferred that Beauveria bassiana strains include strain ATCC 74040 and strain GHA (Accession No. ATCC74250). The liquid preparation according to any one of claims 1 to 17, wherein said fungal species is a nematicidally active fungus.

Nematicidally active fungal microorganisms include D2.1 Muscodor albus, in particular strain QST 20799 (Accession No. NRRL 30547); D2.2 Muscodor roseus, in particular strain A3-5 (Accession No. NRRL 30548); D2.3 Purpureocillium lilacinum (previously known as Paecilomyces lilacinus), in particular P. lilacinum strain 251 (AGAL 89/030550; e.g. BioAct from Bayer CropScience Biologics GmbH), strain 580 (BIOSTAT® WP (ATCC No. 38740) by Laverlam), strain in the product BIO-NEMATON® (T. Stanes and Company Ltd.), strain in the product MYSIS® (Varsha Bioscience and Technology India Pvt Ltd.), strain in the product BIOICONEMA® (Nico Orgo Maures, India), strain in the product NEMAT® (Ballagro Agro Tecnologia Ltda, Brazil), and a strain in the product SPECTRUM PAE L© (Promotora Tecnica Industrial, S.A. DE C.V., Mexico); D2.4 Trichoderma koningii; D2.5 Harposporium anguillullae; D2.6 Hirsutella minnesotensis; D2.7 Monacrosporium cionopagum; D2.8 Monacrosporium psychrophilum; D2.9 Myrothecium verrucaria, in particular strain AARC-0255 (e.g. DiTera™ by Valent Biosciences); D2.10 Paecilomyces variotii, strain Q-09 (e.g. Nemaquim® from Quimia, MX); D2.11 Stagonospora phaseoli (e.g. from Syngenta); D2.12 Trichoderma lignorum, in particular strain TL-0601 (e.g. Mycotric from Futureco Bioscience, ES); D2.13 Fusarium solani, strain Fs5; D2.14 Hirsutella rhossiliensis; D2.15 Monacrosporium drechsleri; D2.16 Monacrosporium gephyropagum; D2.17 Nematoctonus geogenius; D2.18 Nematoctonus leiosporus; D2.19 Neocosmospora vasinfecta; D2.20 Paraglomus sp, in particular Paraglomus brasilianum; D2.21 Pochonia chlamydosporia (also known as Vercillium chlamydosporium), in particular var. catenulata (IMI SD 187; e.g. KlamiC from The National Center of Animal and Plant Health (CENSA), CU); D2.22 Stagonospora heteroderae; D2.23 Meristacrum asterospermum, and D2.24 Duddingtonia flagrans.

In a more preferred embodiment, fungal microorganisms with nematicidal effect are selected from Purpureocillium lilacinum, in particular spores of P. lilacinum strain 251 (AGAL 89/030550); Harposporium anguillullae; Hirsutella minnesotensis; Monacrosporium cionopagum; Monacrosporium psychrophilum; Myrothecium verrucaria, strain AARC-0255; Paecilomyces variotii; Stagonospora phaseoli (commercially available from Syngenta); and Duddingtonia flagrans.

In an even more preferred embodiment, fungal microorganisms with nematicidal effect are selected from Purpureocillium lilacinum, in particular spores of P. Lilacinum strain 251 (AGAL 89/030550); and Duddingtonia flagrans. Most preferably, said fungal strain with nematicidal effect is from the species Purpureocillium lilacinum, in particular P. lilacinum strain 251.

The fungal microorganism producing spores and acting as biological control agent and/or plant growth promoter is cultivated or fermented according to methods known in the art or as described in this application on an appropriate substrate, e. g. by submerged fermentation or solid-state fermentation, e. g. using a device and method as disclosed in WO2005/012478 or WO1999/057239.

Although specific fungal propagules such as microsclerotia (see e.g. Jackson and Jaronski (2009); Production of microsclerotia of the fungal entomopathogen Metarhizium anisopliae and their potential for use as a biocontrol agent for soil-inhabiting insects; Mycological Research 113, pp. 842-850) may be produced by liquid fermentation techniques, it is preferred that the dormant structures or organs according to the present invention are produced by solid-state fermentation. Solid-state fermentation techniques are well known in the art (for an overview see Gowthaman et al., 2001. Appl Mycol Biotechnol (1), p. 305-352).

In another aspect, the present invention relates to a liquid composition comprising the preparation according to the invention and at least one carrier.

A carrier may be any carrier suitable for formulating fungal spores. Carrier often used include plant oils, mineral oils, polyethylenglycols (PEGs) and their derivatives, sugar surfactants, liquid sugars and derivatives, silicon derived liquids (such as organo-modified trisiloxane), ethoxylated sorbitan, sorbitan esters (such as sorbitan monolaurate), alcohol ethoxylates and/or propoxylates, glycerin derivatives (such as glycerin triacetate), oil ethoxylates and propoxylates (such as soybean oil ethoxylates), polymers and block-co-polymers (such as polyalkylene oxide co-polymers), and many others.

In a preferred embodiment, said carrier is a carboxylic ester composed of a carboxylic acid moiety and an alcohol moiety

wherein said carboxylic ester is not a carboxylic acid triglyceride from vegetable oils, and fungal spores of a fungus exerting a beneficial effect on plants,

wherein said at least one carboxylic ester contains
a) a carboxylic monoacid moiety and a monoalcohol moiety
b) at least one carboxylic monoacid moiety and a polyalcohol moiety or
c) a carboxylic polyacid moiety and at least one monoalcohol moiety;

wherein said monoalcohol moiety is a branched, linear, cyclic, acyclic or partially cyclic, saturated or partially unsaturated C1-C24 monoalcohol moiety;

wherein said carboxylic monoacid moiety is a branched, linear, cyclic, acyclic or partially cyclic, saturated or partially unsaturated C2-C24 carboxylic monoacid moiety, optionally carrying at least one OH functionality;

wherein said polyalcohol moiety is a branched, linear, cyclic, acyclic or partially cyclic, saturated or partially unsaturated di-, tri-, tetra-, penta- or hexavalent C2-C20 polyalcohol moiety; and

wherein said carboxylic polyacid moiety is a branched, linear, cyclic, acyclic or partially cyclic, saturated or partially unsaturated C2-C20 carboxylic polyacid moiety.

Such carriers are described in WO which is incorporated herein by reference in its entirety.

In connection with the present invention, the term “carboxylic polyacid” comprises carboxylic acids having two or more carboxyl groups. Accordingly, within the scope of the present invention are dicarboxylic acids, tricarboxylic acids and tetracarboxylic acids.

In one embodiment, any one of a), b) and/or c) is a mixture of esters comprised of more than one different monoalcohol, polyalcohol, carboxylic monacid or carboxylic polyacid moiety. For example, the mixture according to a) may comprise more than one different carboxylic monoacid and/or monoalcohol moiety, the mixture according to b) may comprise more than one different carboxylic monoacid and/or polyalcohol moiety, and/or the mixture according to c) may comprise more than on different carboxylic polyacid and/or monoalcohol moiety.

The liquid preparation, in particular embodiments, may comprise both a mixture of different monoalcohol, polyalcohol, carboxylic monacid or carboxylic polyacid moieties as described above and a mixture of different subgroups a) to c).

In a preferred embodiment, said monoalcohol moiety is derived from a branched, linear, saturated or partially unsaturated C1-C20 monoalcohol. Exemplary and preferred monoalcohols are selected from the group consisting of methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol, undecanol, lauryl alcohol, tridecanol, isotridecanol, myristyl alcohol, pentadecanol, cetyl alcohol, palmitoleyl alcohol, heptadecanol, stearyl alcohol, oleyl alcohol, nonadecanol, eicosanol, and optionally mixtures of any of the foregoing. More preferred monoalcohols comprise methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol, lauryl alcohol, tridecanol, isotridecanol, myristyl alcohol, cetyl alcohol, palmitoleyl alcohol, stearyl alcohol, oleyl alcohol and optionally mixtures of any of the foregoing.

In another preferred embodiment, said at least one carboxylic monoacid moiety is derived from a branched, linear, saturated or partially unsaturated C2-C20 carboxylic monoacid. Exemplary and preferred carboxylic monoacids comprise acetic acid, propionic acid, butyric acid, valeric acid, caproic acid, caprylic acid, capric acid, lauric acid, myristic acid, palmitic acid, stearic acid, isostearic acid, oleic acid, linoleic acid, α-Linolenic acid, ricinolic acid and optionally mixtures of any of the foregoing.

In a preferred embodiment, the at least one polyalcohol moiety is derived from a polyalcohol selected from the group consisting of glycol, 1,3-propandiol, 1-4-butandiol, 1,5-pentandiol, 1,6-hexandiol, cyclohexan-1,2-diol, isosorbid, 1,2-propandiol, neopentylglycol, glycerol, trimethylolpropane, pentaerythritol and sugar alcohols according to the formula HOCH₂(CHOH)ₙCH₂OH (n=2, 3 or 4) and optionally mixtures thereof. Examples of sugar alcohols comprise ethylene glycol, glycerol, erythrol, threitol, arabitol, xylitol, ribitol, mannitol, sorbitol, galactitol, fucitol, iditol, inositol, volemitol, isomalt, maltitol, lactitol, maltotriol, maltotetraitol, polyglycitol and sorbitan. Preferred sugar alcohols are sorbitol and sorbitan. More preferred polyalcohols are 1,2-propandiol, neopentylglycol, glycerol, 1,3-propandiol, trimethylolpropane and sorbitan and optionally mixtures thereof. Even more preferred polyalcohols are 1,2-propandiol, glycerol, 1,3-propandiol and sorbitan and optionally mixtures thereof.

In another preferred embodiment, said at least one carboxylic polyacid moiety is derived from a carboxylic polyacid selected from the group consisting of

(i) a linear, saturated or partially unsaturated C2-C10 dicarboxylic acid

(ii) a cyclic C5-C6 dicarboxylic acid, and

(iii) citric acid and its O-acetylated derivatives, such as O-acetyl citric acid.

Non-limiting preferred examples of said at least one carboxylic polyacid comprise 1,2-cyclohexanedicarboxylic acid, oxalic acid, malonic acid, maleic acid, fumaric acid, succinic acid, 2-hydroxy succinic acid, glutaric acid, adipic acid, pimelic acid, 0-acetyl citric acid and citric acid. As can be seen from the examples, 1,2-cyclohexanedicarboxylic acid, adipic acid, 0-acetyl citric acid and glutaric acid, of which 1,2-cyclohexanedicarboxylic acid, adipic acid and O-acetyl citric acid have been successfully tested according to the present invention, are most preferred.

The at least one carboxylic monoacid or at least one carboxylic polyacid to be comprised in the carboxylic ester according to the invention may carry at least one OH functionality.

The at least one polyalcohol giving rise to the polyalcohol moiety as comprised in certain embodiments of said at least one carboxylic ester according to b) may be partially or fully esterified. In other words, the polyalcohol may be esterified at one or more of its functional OH groups up to all functional OH groups present in the resulting polyalcohol moiety. Accordingly, in a polyalcohol moiety comprising three functional OH groups, such as glycerol, one or two or all three OH groups may be esterified with a carboxylic monoacid to form a carboxylic ester according to b), and in a polyalcohol moiety comprising two functional OH groups, such as 1,3-propandiol, one or both OH groups may be esterified with a carboxylic monoacid to form a carboxylic ester according to b).

As to the carboxylic ester according to a), it is preferably composed of at least one branched, linear, saturated or partially unsaturated C2-C20 carboxylic acid moiety and at least one branched, linear, saturated or partially unsaturated C1-C20 monoalcohol moiety.

Preferably, the number of C-atoms in the carboxylic ester according to a) ranges between 13 and 28.

Preferably, the monoalcohol forming the alcohol moiety according to a) is selected from the group consisting of methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol, undecanol, lauryl alcohol, tridecanol, isotridecanol, myristyl alcohol, pentadecanol, cetyl alcohol, palmitoleyl alcohol, heptadecanol, stearyl alcohol, oleyl alcohol, nonadecanol, eicosanol and optionally mixtures of any of the foregoing.

In the carboxylic ester according to a), said carboxylic monoacid moiety is preferably derived from a carboxylic monoacid selected from the group consisting of acetic acid, propionic acid, butyric acid, valeric acid, caproic acid, caprylic acid, capric acid, lauric acid, myristic acid, palmitic acid, stearic acid, isostearic acid, oleic acid, linoleic acid, a-linolenic acid, ricinolic acid and optionally mixtures of any of the foregoing. More preferably, in particular with the carboxylic monoacids as above, the corresponding monoalcohol moiety is derived from a monoalcohol selected from the group consisting of methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol, lauryl alcohol, tridecanol, isotridecanol, myristyl alcohol, cetyl alcohol, palmitoleyl alcohol, stearyl alcohol, oleyl alcohol and optionally mixtures of any of the foregoing. In one more preferred embodiment, the methylated and/or ethylated seed oils as listed above are not comprised within the scope of the present invention.

Particularly preferred carboxylic esters according to a) comprise a carboxylic monoacid moiety derived from a carboxylic monoacid selected from the group consisting of acetic acid, propionic acid, butyric acid, valeric acid, caproic acid, caprylic acid and capric acid and optionally mixtures thereof and a monoalcohol moiety derived from a monoalcohol selected from the group consisting of lauryl alcohol, tridecanol, isotridecanol, myristyl alcohol, cetyl alcohol, palmitoleyl alcohol, stearyl alcohol, oleyl alcohol and optionally mixtures thereof.

Other particularly preferred carboxylic esters according to a) comprise a carboxylic monoacid moiety derived from a carboxylic monoacid selected from the group consisting of lauric acid, myristic acid, palmitic acid, stearic acid, oleic acid, linoleic acid, a-linolenic acid, ricinolic acid and optionally mixtures thereof, and a monoalcohol moiety derived from a monoalcohol selected from the group consisting of methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol and optionally mixtures thereof. In one more preferred embodiment, the methylated and/or ethylated seed oils as listed above are not comprised within the scope of the present invention.

As shown in the examples, carboxylic esters according to a) which are 2-ethylhexyl laurate, 2-ethylhexyl palmitate, 2-ethylhexyl oleate, ricinolic acid methylester and propionic acid pentyl ester have been shown to exert the stabilizing effect according to the invention and are thus particularly preferred.

With regard to the present invention, the term “stabilizing” or “stabilization” preferably and in particular refers to preventing a substantial loss in the ability to germinate after storage, rather than preventing germination during storage.

Preferred carboxylic esters according to b) comprise a carboxylic monoacid moiety derived from a carboxylic monoacid selected from the group consisting of acetic acid, propionic acid, butyric acid, valeric acid, caproic acid, caprylic acid, capric acid, lauric acid, myristic acid, palmitic acid, stearic acid, isostearic acid, oleic acid, linoleic acid, a-linolenic acid, ricinolic acid and optionally mixtures thereof, and a polyalcohol moiety derived from a polyalcohol selected from the group consisting of 1,2-ethandiol, 1,3-propandiol, 1-4-butandiol, 1,5-pentandiol, 1,6-hexandiol, cyclohexan-1,2-diol, isosorbid, 1,2-propandiol, neopentylglycol, glycerol, pentaerythritol, trimethylolpropan, sugar alcohols and optionally mixtures thereof.

In a more preferred embodiment, in said at least one carboxylic ester according to b), said carboxylic monoacid moiety is derived from a branched, linear, cyclic, acyclic or partially cyclic, saturated or partially unsaturated C2-C6 carboxylic monoacid, optionally carrying at least one OH functionality, preferably a C2 to C5 carboxylic monoacid moiety. In this preferred embodiment, it is even more preferred that the corresponding polyalcohol moiety is derived from 1,2-propandiol, neopentylglycol, glycerol, 1,3-propandiol, trimethylolpropane and sorbitan and optionally mixtures thereof. Even more preferred polyalcohols are 1,2-propandiol, glycerol, 1,3-propandiol and sorbitan and optionally mixtures thereof.

In an alternative more preferred embodiment, in said at least one carboxylic ester according to b), said carboxylic monoacid moiety is derived from a carboxylic monoacid selected from the group consisting of acetic acid, propionic acid, butyric acid, valeric acid, caproic acid and optionally mixtures thereof, and said polyalcohol moiety is derived from a polyalcohol selected from the group consisting of neopentylglycol, pentaerythritol, trimethylolpropan and optionally mixtures thereof.

In another more preferred embodiment which may optionally combined with the embodiments immediately above the present embodiment, in said at least one carboxylic ester according to b), said polyalcohol moiety is

a cyclic or partially cyclic, saturated or partially unsaturated C2-C20-divalent, C3-C20-trivalent, C4-C20-tetravalent, C-5-C20-pentavalent or C6-C20-hexavalent polyalcohol moiety; or

a polyalcohol of the following formula II

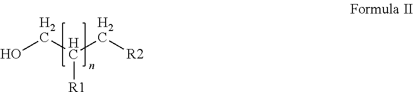

where n is an integer between 0 and 4,

where R1 and R2 are independent from each other hydrogen or hydroxy,

where R2 is C1-C9 alkyl if n=1 and R1=OH.

Alternative more preferred carboxylic esters according to b) comprise a carboxylic monoacid moiety derived from a carboxylic monoacid selected from the group consisting of acetic acid, propionic acid, butyric acid, valeric acid, caproic acid, caprylic acid, capric acid, lauric acid, myristic acid, palmitic acid, stearic acid, isostearic acid, oleic acid, linoleic acid, a-linolenic acid, ricinolic acid and optionally mixtures thereof, and a polyalcohol moiety derived from a polyalcohol selected from the group consisting of 1,2-ethandiol, 1,3-propandiol, 1-4-butandiol, 1,5-pentandiol, 1,6-hexandiol, cyclohexan-1,2-diol, isosorbid, 1,2-propandiol, glycerol, sugar alcohols and optionally mixtures thereof.

Preferably, the number of C-atoms in the carboxylic ester according to b) ranges between 9 and 60 carbon atoms, more preferably between 9 and 40.

In one particularly preferred embodiment of the carboxylic esters according to b), said polyalcohol moiety is derived from a cyclic or partially cyclic, saturated or partially unsaturated C2-C20-divalent, C3-C20-trivalent, C4-C20-tetravalent, C-5-C20-pentavalent or C6-C20-hexavalent polyalcohol. Here, it is even more preferred that said cyclic or partially cyclic polyalcohol moiety is derived from a sugar alcohol as described further above, i.e. comprising ethylene glycol, glycerol, erythrol, threitol, arabitol, xylitol, ribitol, mannitol, sorbitol, galactitol, fucitol, iditol, inositol, volemitol, isomalt, maltitol, lactitol, maltotriol, maltotetraitol, polyglycitol and sorbitan.

Particularly preferred polyalcohol moieties comprised in the carboxylic esters according to b) are derived from 1,2-ethandiol, 1,2-propandiol, neopentylglycol, 1,3-propandiol and sorbitan and optionally mixtures thereof. For example for glycerol as polyalcohol, acetic acid, propionic acid, butyric acid, valeric acid, caproic acid, caprylic acid and capric acid and optionally mixtures thereof as carboxylic monoacid to form the carboxylic acid moiety are especially preferred. For diacetylglycerol as polyalcohol, acetic acid, propionic acid, butyric acid, valeric acid, caproic acid, caprylic acid, capric acid, lauric acid, myristic acid, palmitic acid, stearic acid, isostearic acid, oleic acid, linoleic acid, α-linolenic acid and ricinolic acid and optionally mixtures thereof as carboxylic acid forming the carboxylic acid moiety are especially preferred. Another set of particularly preferred carboxylic esters according to b) are derived from neopentylglycol, trimethylolpropane and pentaerythritol polyalcohol moieties and acetic acid as carboxylic monoacid moiety.

In connection with all embodiments relating to the carboxylic esters according to b), it is generally preferred that if the polyalcohol moiety is derived from neopentylglycol, the carboxylic monoacid moiety is not derived from capric acid, and/or if the polyalcohol moiety is derived from pentaerythrol, the carboxylic monoacid moiety is not derived from 2-ethylhexanoic acid and/or if the polyalcohol moiety is derived from trimethylpropane, the carboxylic monoacid moiety is not derived from n-octadecanoic acid.

More preferably, relating to the carboxylic esters according to b), provided that the polyalcohol moiety is derived from neopentylglycol, trimethylpropane or pentaerythrol, the carboxylic acid moiety is not derived from carboxylic monoacids having 7 to 18 carbon atoms.

As shown in the examples, carboxylic esters according to b) which are propylene glycol dicaprylate, propylene glycol dicaprate, neopentylglycol dicocoate, glycerol triacetate, trimethylolpropane triisostearate, trimethylolpropane tricocoate, glycerol tricaprylate, glycerol tricaprate, C12-C18 carboxylic acid monoglyceride diacetate (C12-C18 carboxylic acids forming the group of fatty acids), trimethylolpropane tricaprylate, trimethylolpropane tricaprate, trimethylolpropane trioleate and sorbitan trioleate have been shown to exert the stabilizing effect according to the invention and are thus particularly preferred.

As to the carboxylic ester according to c), said carboxylic polyacid moiety is preferably derived from linear, saturated or partially unsaturated C2-C10 dicarboxylic acids, cyclic C5-C6 dicarboxylic acids and o-acetyl citric acid and optionally mixtures thereof. More preferably, said carboxylic polyacid moiety is derived from a carboxylic polyacid selected from the group consisting of linear, saturated C3-C8 dicarboxylic acids, 1,2-cyclohexanedicarboxylic acid and o-acetyl citric acid and optionally mixtures thereof. Even more preferably, said carboxylic polyacid moiety is derived from a carboxylic polyacid selected from the group consisting of 1,2-cyclohexanedicarboxylic acid, glutaric acid, adipic acid and 0-Acetyl citric acid and optionally mixtures thereof. In another more preferred embodiment, said carboxylic polyacid moiety is derived from a carboxylic polyacid selected from the group consisting of 1,2-cyclohexanedicarboxylic acid, glutaric acid and O-Acetyl citric acid and optionally mixtures thereof.

Preferably, the number of C-atoms in the carboxylic ester according to c) ranges between 10 and 40, more preferred between 10 and 30, and even more preferred between 10 and 20.

Alternatively or in addition to the above embodiments characterizing the carboxylic polyacid moiety in the carboxylic ester according to c), the monoalcohol moiety in the carboxylic ester according to c) is derived from a monoalcohol selected from the group consisting of methanol, ethanol, 1-propanol, 2-propanol, 1-butanol, 2-butanol, isobutanol, pentan-1-ol, pentan-2-ol, pentan-3-ol, 2-methylbutan-1-ol, 2-methylbutan-2-ol, 3-methylbutan-1-ol, 3-methylbutan-2-ol, 2,2-dimethylpropan-1-ol, 1-hexanol, 1-heptanol, 2-ethylhexan-1-ol, capryl alcohol, pelargonic alcohol, isononyl alcohol, capric alcohol, lauryl alcohol, tridecanol, isotridecanol, myristyl alcohol, cetyl alcohol, palmitoleyl alcohol, stearyl alcohol, oleyl alcohol and optionally mixtures thereof.

In one preferred embodiment of the carboxylic ester according to c), said carboxylic polyacid moiety is derived from linear C3-C8 dicarboxylic acid and the monoalcohol moiety is derived from a C1-C5 monoalcohol.

In another preferred embodiment of the carboxylic ester according to c), said carboxylic polyacid moiety is derived from cyclic dicarboxylic and tricarboxylic acids and the monoalcohol moiety is derived from a C1-C24 monoalcohol.

In all embodiments relating to the carboxylic esters according to c), it is particularly preferred that if the carboxylic polyacid moiety is derived from adipic acid, the monoalcohol moiety is not derived from isodecyl alcohol or 2-heptylundecyl alcohol. In other particularly preferred embodiment, the carboxylic esters according to c) are not derived from adipic acid and monoalcohol moieties having 6 to 18 carbon atoms.

Alternatively or in addition to the above embodiments characterizing the carboxylic esters according to c), the monoalcohol moiety in combination with linear carboxylic polyacid moieties is selected from the group consisting of methanol, ethanol, 1-propanol, 2-propanol, 1-butanol, 2-butanol and isobutanol.

As another alternative or in addition to the above embodiments characterizing the carboxylic esters according to c), the monoalcohol moiety in combination with cyclic C5-C6 dicarboxylic acids and o-acetyl citric acid or mixtures thereof is selected from the group consisting of methanol, ethanol, 1-propanol, 2-propanol, 1-butanol, 2-butanol, isobutanol, 1-hexanol, 1-heptanol, 2-ethylhexan-1-ol, capryl alcohol, pelargonic alcohol, isononyl alcohol, capric alcohol, lauryl alcohol, tridecanol, isotridecanol, myristyl alcohol, cetyl alcohol, palmitoleyl alcohol, stearyl alcohol, oleyl alcohol and optionally mixtures thereof.

As shown in the examples, carboxylic esters according to c) which are 1,2-cyclohexane dicarboxylic acid diisononyl ester, di-n-butyl adipate, diisopropyl adipate and O-acetyl citric acid tributyl ester have been shown to exert the stabilizing effect according to the invention and are thus particularly preferred.

Exemplary and preferred carriers which are carboxylic esters according to the above definition include the following:

| Trade name | Chemical description | Supplier | CAS-No. | type |
|---|---|---|---|---|
| Radia 7127 | 2-Ethylhexyl laurate | Oleon | 20292-08-4 | Monoalcohol- |
| | | | | Monoacid a) |
| Radialube 7130/ | 2-Ethylhexyl oleate | Oleon | 26399-02-2 | Monoalcohol- |
| Radia 7331 | | | | Monoacid a) |
| Radia7081 | Ricinolic acid methylester | Oleon | 141-24-2 | Monoalcohol- |
| | | | | Monoacid a) |
| Pentyl Propionate | Propionic acid Pentyl ester | Sigma- | 624-54-4 | Monoalcohol- |
| | | Aldrich | | Monoacid a) |
| Radia 7208 | Propylene glycol dicaprylate/ | Oleon | 68583-51-7 | Dialcohol- |
| | caprate | | | Monoacid b) |
| Radialube 7302 | Neopentylglycol dicocoate | Oleon | 68038-32-4 | Dialcohol- |
| | | | | Monoacid b) |
| Triacetin | Glycerin triacetate | Sigma- | 102-76-1 | Trialcohol- |
| | | Aldrich | | Monoacid b) |
| Radia 7380 | Trimethylolpropane | Oleon | 68541-50-4 | Trialcohol- |
| | Triisostearate | | | Monoacid b) |
| Radialube 7359 | Trimethylolpropane | Oleon | 85566-29-6 | Trialcohol- |
| | Tricocoate | | | Monoacid b) |
| Miglyol 812 | Glycerin Tricaprylate/Caprate | Sasol | 73398-61-5 | Trialcohol- |
| | | | | Monoacid b) |
| Radia 7909 | Fatty acid monoglyceride | Oleon | | Trialcohol- |
| | diacetate | | | Monoacid b) |
| Radia 7368 | Trimethylolpropane | Oleon | 11138-60-6 | Trialcohol- |
| | Tricaprylate/Caprate | | | Monoacid b) |
| Radialube 7361 | Trimethylolpropane Trioleate | Oleon | 57675-44-2 | Trialcohol- |
| | | | | Monoacid b) |
| Radiasurf 7355 | Sorbitan trioleate | Oleon | 26266-58-0 | Polyalcohol- |
| | | | | Monoacid b) |
| Agnique AE829 | 1,2-Cyclohexane dicarboxylic | BASF | 166412-78-8 | Monoalcohol- |
| | acid diisononyl ester | | | Diacid c) |
| Adimoll DB | di-n-Butyl adipate | LanXess | 105-99-7 | Monoalcohol- |
| | | | | Diacid c) |
| Crodamol DA | Diisopropyl adipate | Croda | 6938-94-9 | Monoalcohol- |
| | | | | Diacid c) |
| Acetyltributyl | O-Acetyl citric acid tributyl | Sigma- | 77-90-7 | Monoalcohol- |
| citrate | ester | Aldrich | | Triacid c) |

In another preferred embodiment, said at least one carrier is an ethoxylated and/or propoxylated organic liquid which is selected from the group consisting of
a) ethoxylated fatty acid triglycerides with 3-10 ethylene oxide units, wherein the fatty acid triglycerides are selected from the group consisting of castor oil and plant oils;
b) a block copolymer of the general formula

H—O—[CH2-CH2-O—]a1-[CH2-CH(CH3)-O]b-[CH2-CH2-O—]a2-H

where a1, a2 and b have independently from each other an average value of between 1 and 10; or where a1 and a2 have independently from each other an average value of between 1 and 20 and b has an average value of between 15 and 35; and
c) a polymer of the general formula

X—O—[CH2-CH(CH3)-O]m-[CH2-CH2-O—]n-Y
where X and Y are independently selected from hydrogen, branched or linear alkyl with 1-24 carbon atoms, and branched or linear carbonyl with 2-24 carbon atoms, saturated or partially unsaturated, optionally carrying hydroxyl functionality;
where m is an average number between 0 and 10;
where n is an average number between 0 and 40, preferably between 0 and 30, more preferably between 0 and 20; most preferably between 0 and 15 or even between 0 and 10; where m+n is not zero.

In a preferred embodiment, said ethoxylated fatty acid triglycerides according to a) are derived from plant oils selected from the group consisting of sunflower oil, rapeseed oil, soybean oil, corn oil, coconut oil, and palm oil. For a review of the composition of said plant oils, please refer to http://www.dgfett.de/material/fszus.php.

In another preferred embodiment, said ethoxylated fatty acid triglycerides according to a) are derived from castor oil. Selected examples of ethoxalyted castor oils are e.g. Lucramul C008 (Castor oil ethoxylate 8EO) and Etocas 10 (Castor oil ethoxylate 10EO) which are particularly preferred. Of this group Etocas 10 is most preferred.

As to the ethoxylated and propoxylated organic liquid according to b), this is preferably selected from the group consisting of Block-Copolymers of the formula H—O—[CH2-CH2-O-]a1-[CH2-CH(CH3)-O]b-[CH2-CH2-O-]a2-H where a1 and a2 have independently from each other an average value of between 1 and 20 and b has an average value of between 15 and 35. More preferably, said ethoxylated and propoxylated organic liquid is selected from the group of Block-Copolymers where a1 and a2 have independently from each other an average value of between 1 and 16 and where b has an average value of between 20 and 30.Said ethoxylated and propoxylated organic liquid according to b) preferably has an average mol wt. of between about 1000 and about 3000 g/mol, more preferably between about 1500 g/mol and about 3000 g/mol, more preferably between about 2000 g/mol and about 3000 g/mol.

For example, for Block-Copolymers with an average value of a1 and a2 of between 3 and 16 and an average value of b of between 25 and 35, the average molecular weight may range between about 2000 and about 3000 g/mol. For Block-Copolymers with an average value of a1 and a2 of between 2 and 12 and an average value of b of between 15 and 25, the average molecular weight may range between about 1400 and about 2200 g/mol. For Block-Copolymers with an average value of a1 and a2 of between 1 and 12 and an average value of b of between 10 and 20, the average molecular weight may range between about 1000 and about 2000 g/mol.

Selected examples for ethoxylated and propoxylated organic liquid according to b) are represented by Synperonic PE/L62, Synperonic PE/L64 and Synperonic PE/L44 which are particularly preferred.

In another embodiment, the ethoxylated and propoxylated organic liquid according to b) is preferably selected from the group consisting of Block-Copolymers of the formula H—O—[CH2-CH2-O-]a1-[CH2-CH(CH3)-O]b-[CH2-CH2-O-]a2-H where a1, a2 and b have independently from each other an average value of between 1 and 8. More preferably, said Block-Copolymer has an average amount of 2 to 8 propylene oxide units and 2 to 12 ethylene oxide units, where a1 and a2 may independently from each other have a value not exceeding 12 in total. Even more preferably, said Block-Copolymer has an average amount of 2 to 6 propylene oxide units and 2 to 8 ethylene oxide units, where a1 and a2 may independently from each other have a value not exceeding 8 in total.

In this embodiment, said ethoxylated and propoxylated organic liquid according to b) preferably has an average mol wt. of between about 150 and about 1500 g/mol, more preferably between about 150 g/mol and about 1200 g/mol, more preferably between about 200 g/mol and about 1000 g/mol and even more preferably between about 200 and about 700 g/mol.

For example, for an average value of a1, a2 and b independently from each other of between 1 and 10, the average molecular weight may range between about 150 and about 1500 g/mol. For an average value of a1, a2 and b independently from each other of between 1 and 8, the average molecular weight may range between about 150 and about 1200 g/mol. For Block-Copolymers with an average amount of 2 to 8 propylene oxide units and 2 to 12 ethylene oxide units, where a1 and a2 may independently from each other have a value not exceeding 12 in total, the average molecular weight may range between about 200 g/mol and about 1000 g/mol. For Block-Copolymers with an average amount of 2 to 6 propylene oxide units and 2 to 8 ethylene oxide units, where a1 and a2 may independently from each other have a value not exceeding 8 in total, the average molecular weight may range between about 200 and about 700 g/mol.

In this embodiment, it is most preferred that in said ethoxylated and propoxylated organic liquid according to b), a1 and a2 have independently from each other a value of between 1 to 4 and b has a value of between 2 to 6.

In a preferred embodiment, in the polymer of c), X is branched or linear alkyl with 1-18 carbon atoms or branched or linear carbonyl with 2-18 carbon atoms, saturated or partially unsaturated, and Y is hydrogen, or branched or linear alkyl with 1-6 carbon atoms or branched or linear carbonyl with 2-6 carbon atoms, saturated or partially unsaturated. For the sake of clarity, the skilled person is aware that branched alkyl or carbonyl groups may only exist with at least 3 carbon atoms.

In an alternative preferred embodiment, in the polymer of c), X is hydrogen, or branched or linear alkyl with 1-6 carbon atoms (for the sake of clarity throughout the present application branched moieties have to have at least 3 carbon atoms), or branched or linear carbonyl with 2-6 carbon atoms, saturated or partially unsaturated, optionally carrying hydroxyl functionality and Y is branched or linear alkyl with 1-18 carbon atoms or branched or linear carbonyl with 2-18 carbon atoms, saturated or partially unsaturated, optionally carrying hydroxyl functionality. In a preferred embodiment, in the polymer of c) m+n is between 1 and 30, more preferably between 1 and 20, most preferably between 1 and 15. In an alternative preferred embodiment, m is in a range between 1 and 9 and n is in a range of between 0 and 6., or m is in a range of between 0 and 5 and n is in a range of between 3 and 10. In yet another preferred embodiment, m is in a range of between 1 to 5 where n equals zero, or n is in a range of between 4 and 10 where m equals zero.

In the foregoing, carbonyl refers to alkylcarbonyl, alkenylcarbonyl, alkinylcarbonyl as defined below.

Whereas the skilled person is able to define which liquids fall within the scope of the present invention, it is preferred that said ethoxylated and/or propoxylated organic liquid according to c) is selected from the group consisting of polyethylene glycols, such as Pluriol E300 (polyethyleneglycol-300); ethoxylated alcohols, such as Atplus 245 (alcohol ethoxylate), Berol 050 (linear C12-C16 ethoxylated alcohol, 3EO), Berol 260 (C9-C11 ethoxylated alcohol, 4EO), Ecosurf EH3 (Triethylenglycol-monooctylether), Lucramul L03 (C12-C18 ethoxyated alcohols, 3EO), Lucramul L05 (C12-C18 ethoxyated alcohols, 5EO), Lutensol A03 (C13-15-branched and linear ethoxylated alcohols, 3EO), Lutensol A07 (C13-15-branched and linear ethoxylated alcohols, 7EO), Triethylenglycolmonobutylether; mono-/polyethylene oxide diethers, such as Tetraglyme (Tetraethylenglycol diether); mono-/polyethylene oxide ether-ester, such as Arlatone TV (Sorbitol-Heptaoleate, 40EO), n-Butyldiglycolacetat, Tween 20 (ethoxylated sorbitol monolaurate, 20EO), Tween-80 (ethoxylated sorbitol monooleate, 20EO), Tween-85 (ethoxylated sorbitol monooleate, 20EO); ethoxylated carboxylic acids, such as Alkamuls A (Polyethylene glycol Monooleate), Radiasurf 7402 (polyethyleneglycol-200 monooleate), Radiasurf 7403 (polyethyleneglycol-400 monooleate), Radiasurf 7423 (polyethyleneglycol-400 monolaurate); mono-/polyethylene oxide di-esters, such as Radiasurf 7442 (polyethyleneglycol-400 dioleate); polypropylene glycols, such as Dipropylene glycol; propoxylated alcohols, such as Dowanol DPM (Dipropylene Glycol monomethyl ether); mono-/polypropylene oxide diethers, such as Dipropylene glycol dimethyl ether; mono-/polypropylene oxide ether-ester, such as Dipropylene glycol methyl ether acetate; propoxylated carboxylic acids; mono-/polypropylene oxide di-esters, such as Propylenglycol diacetate; alcohol propoxylate-ethoxylates, such as Atlas G-5002L (Alcohol propoxylate-ethoxylate), Lucramul HOT 5902 (Alcohol propoxylate-ethoxylate); carboxylic acid propoxylate-ethoxylate; carboxylic acid propoxylate-ethoxylate ether, such as Leofat OC0503M (Fatty acid, Propoxylated-ethoxylated, end-capped Methyl Fatty acid, Propoxylated-ethoxylated, end-capped Methyl).

Especially preferred carriers are selected from the group consisting of Radiasurf 7403, Radiasurf 7442, Triton X 100, PEG300, triacetin, Atlas G5002 and Tween20 and even more so Radiasurf 7403, Triacetin, Atlas G5002L and Tween 20.

Another class of carriers belong to organo-modified siloxanes, in particular to polyether-modified trisiloxanes of formula I

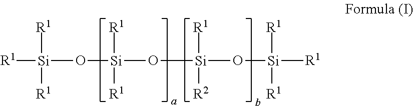

where

R¹ represents independent from each other identical or different hydrocarbyl radicals having 1-8 carbon atoms, preferred methyl-, ethyl-, propyl- and phenyl radicals, particularly preferred are methyl radicals.

a=0 to 1, preferred 0 to 0.5, particularly preferred 0,

b=0.8 to 2, preferred 1 to 1.2, particularly preferred 1,

in which: a+b<4 and b>a, preferred a+b<3 and particularly preferred a+b<2.

R² represents independent from each other identical or different polyether radicals of general formula (II)

-R³O[CH₂CH₂O]_{c}[CH₂CH(CH₃)O]_{d}[CHR⁴CHR⁴O]ₑR⁵ Formula (II)

R³=independent from each other identical or different, bivalent hydrocarbyl radicals having 2-8 carbon atoms, which are optionally interrupted by oxygen atoms, preferred rest is the general formula (III) when n=2-8, particularly preferred —CH₂—CH₂—CH₂—,

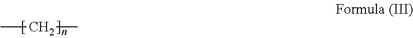

R⁴=independent from each other identical or different hydrocarbyl radicals having 1-12 carbon atoms or hydrogen radical, preferably a methyl-, ethyl-, phenyl- or a hydrogen radical.

R⁵=independent from each other identical or different hydrocarbyl radicals having 1-16 carbon atoms, which are optionally contain urethane functions, carbonyl functions or carboxylic acid ester functions, or hydrogen radical, preferred methyl or H, particularly preferred H.

C=0 to 40, preferred 1 to 15, particularly preferred 2 to 10

d=0 to 40, preferred 0 to 10, particularly preferred 1 to 5

e=0 to 10, preferred 0 to 5, particularly preferred 0,

in which c+d+e>3

The polyether-modified trisiloxanes described above can be prepared by methods well known to the practioner by hydrosilylation reaction of a Si-H containing siloxane and unsaturated polyoxyalkylene derivatives, such as an allyl derivative, in the presence of a platinum catalyst. The reaction and the catalysts employed have been described for example, by W. Noll in “Chemie und Technologie der Silicone”, 2^{nd} ed., Verlag Chemie, Weinheim (1968), by B. Marciniec in “Appl. Homogeneous Catal. Organomet. Compd. 1996, 1, 487). It is common knowledge that the hydrosilylation products of SiH-containing siloxanes with unsaturated polyoxyalkylene derivatives can contain excess unsaturated polyoxyalkylene derivative.

Examples of water soluble or self-emulsifiable polyether-modified (PE/PP or block-CoPo PEPP) trisiloxanes include but are not limited to those described by CAS-No 27306-78-1 (e.g. Silwet L77 from MOMENTIVE), CAS-No 134180-76-0 (e.g. BreakThru S233 or BreakThru S240 e.g. from Evonik), CAS-No 67674-67-3 (e.g Silwet 408 from WACKER), other BreakThru-types, and other Silwet-types. Preferred polyether-modified trisiloxanes include those described by CAS-No 134180-76-0, in particular Break-Thru S240.

In a particular embodiment, the invention provides for a liquid preparation comprising

0.1-40% of fungal spores, preferred 2.5-30%, most preferred 5-25%, such as 10-20%,

up to 99.9% of a carrier as defined above, preferred 70 up to 97.5%, most preferred 75 up to 95%; such as 80-90%,

0-10% of surfactants (e.g. dispersants emulsifiers); preferred 0-8%, most preferred 0.1-5%;

0-10% of rheology modifiers, e.g. fumed silicas, attapulgites, preferably 0-7%, more preferably 0.5-5%;

0-5% of each antifoams, antioxidants, dyes preferred 0-3%, most preferred 0.1-0.5% of each.

As long as not defined otherwise, the term “alkyl” refers to saturated straight-chain or branched hydro-carbon radicals such as (C1-C18)-, (C1-C6)-, or (C1-C4)-alkyl. Examples of C1-C4 alkyl include methyl, ethyl, propyl, 1-methylethyl, butyl. Examples of (C1-C6)-alkyl include methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, and 1-ethyl-2-methylpropyl.

As long as not defined otherwise, the term “alkenyl” refers to unsaturated straight-chain or branched hydrocarbon radicals comprising at least one double bond such as (C2-C18)-, (C2-C6)- or (C2-C4)-alkenyl. Examples of (C2-C4)-alkenyls include ethenyl, 1-propenyl, 3-butenyl etc. Examples of (C2-C6)-alkenyls include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl.

As long as not defined otherwise, the term “alkoxy” (alkyl-O—) refers to alkyl radicals bound to the scaffold via an oxygen atom (—O—) such as (C1-C18)-, (C1-C6)- or (C1-C4)-alkoxy. Examples of (C1-C4)-alkoxy include methoxy, ethoxy, propoxy, 1-methylethoxy. Examples of (C1-C6)-alkoxy include methoxy, ethoxy, propoxy, 1-methylethoxy, butoxy, 1-methylpropoxy, 2-methylpropoxy, 1,1-di-methylethoxy, pentoxy, 1-methylbutoxy, 2-methylbutoxy, 3-methylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy, and 1-ethyl-2-methylpropoxy.

Likewise, as long as not defined otherwise, the terms “alkenoxy” and “alkynoxy” refer to alkenyl or, respectively, alkynyl radicals bound to the scaffold via —O— such as (C2-C18)-, (C2-C6)- or (C2-C4)-alkenoxy or, respectively, (C3-C10)-, (C3-C6)- or (C3-C4)-alkynoxy.

As long as not defined otherwise, the term “alkylcarbonyl” (alkyl-C(═O)—) refers to alkyl radicals bound to the scaffold via —C(═O)— such as (C1-C18)-, (C1-C6)- or (C1-C4)-alkylcarbonyl. The number of C-atoms thereby refers to the alkyl radical within the alkylcarbonyl group.

Likewise, as long as not defined otherwise, the terms “alkenylcarbonyl” and “alkynylcarbonyl” refer to alkenyl or, respectively, alkynyl radicals bound to the scaffold via —C(═O)— such as (C2-C18)-, (C2-C6)- or (C2-C4)-alkenylcarbonyl or, respectively, (C2-C10)-, (C2-C6)- or (C2-C4)-alkynylcarbonyl. The number of C-atoms thereby refers to the alkenyl or, respectively, alkynyl radical within the alkenylcarbonyl or, respectively, alkynylcarbonyl group.

As long as not defined otherwise, the term “alkoxycarbonyl” (alkyl-O—C(═O)—) refers to alkyl radicals bound to the scaffold via —O—C(═O)— such as (C1-C18)-, (C1-C6)- or (C1-C4)-alkoxy-carbonyl. The number of C-atoms thereby refers to the alkyl radical within the alkoxycarbonyl group.

Likewise, as long as not defined otherwise, the terms “alkenoxycarbonyl” and “alkynoxycarbonyl” refer to alkenyl or, respectively, alkynyl radicals bound to the scaffold via —O—C(═O)— such as (C2-C10)-, (C2-C6)- or (C2-C4)-alkenoxycarbonyl or, respectively, (C3-C10)-, (C3-C6)- or (C3-C4)-alkynoxycarbonyl. The number of C-atoms thereby refers to the alkenyl or, respectively, alkynyl radical within the alkenoxycarbonyl or, respectively, alkynoxycarbonyl group.

As long as not defined otherwise, the term “alkylcarbonyloxy” (alkyl-C(═O)—O—) refers to alkyl radicals bound to the scaffold via —C(═O)—O—such as (C1-C10)-, (C1-C6)- or (C1-C4)-alkylcarbonyloxy. The number of C-atoms thereby refers to the alkyl radical within the alkylcarbonyloxy group.

Likewise, as long as not defined otherwise, the terms “alkenylcarbonyloxy” and “alkynylcarbonyloxy” refer to alkenyl or, respectively, alkynyl radicals bound to the scaffold via —C(S)—O— such as (C2-C10)-, (C2-C6)- or (C2-C4)-alkenylcarbonyloxy or, respectively, (C2-C10)-, (C2-C6)- or (C2-C4)-alkynylcarbonyloxy. The number of C-atoms thereby refers to the alkenyl or, respectively, alkynyl radical within the alkenylcarbonyloxy or, respectively, alkynylcarbonyloxy group.

Exemplary and preferred carriers which are an ethoxylated and/or propoxylated organic liquid include the following:

| Name | CAS-No. | Description | supplier | fluid type |
|---|---|---|---|---|
| Atlas G5002L | 99821-01-9 | Alcohol propoxylate-ethoxylate | Croda | c) |
| Alkamuls A | CAS 9004-96-0 | Polyethylene glycol Monooleate | Solvay | c) |
| Arlatone TV | CAS 54846- | Sorbitol-Heptaoleate, 40EO | Croda | c) |
| | 79-6 | | | |
| Atplus 245 | | Alcohol ethoxylate | Croda | c) |
| Berol 050 | 68551-12-2 | Linear ethoxylated alcohol C12-C16, | Akzo-Nobel | c) |
| | | 3EO, HLB 8 | | |
| Berol 260 | | ethoxylated alcohol C9-C11 4EO, | Akzo-Nobel | c) |
| | | HLB 10,5 | | |
| Butylcarbitol | 112-34-5 | diethylenglycol monobutylether | Dow | — |
| Butylcellosolve | 111-76-2 | Ethylenglycolmonobutylether | Dow | — |
| Carbitol | CAS 111-90-0 | Diethylenglycolmonoethyl ether | Dow | — |
| Dipropylene glycol | 110-98-5 | | ABCR | c) |
| Dipropylene glycol | 111109-77-4 | Dipropylene glycol dimethyl ether | Sigma-Aldrich | c) |
| DME | | | | |
| Dipropylene glycol | 88917-22-0 | | Sigma-Aldrich | c) |
| methyl ether acetate | | | | |
| Dowanol DPM | | Dipropylene Glycol monomethyl ether | Dow | c) |
| Dowanol TPM | 25498-49-1 | Tripropylene Glycol monomethyl | Dow | c) |
| | | ether | | |
| Ecosurf EH3 | 64366-70-7 | Triethylenglycol-monooctylether | Dow | c) |
| Etocas 10 | 61791-12-6 | Ethoxylated Castor oil 10EO, HLB 6,6 | Croda | a) |
| Hexylcellosolve | 112-25-4 | Ethylenglycolmonohexylester | Dow | — |
| Leofat OC0503M | | Fatty acid, Propoxylated-ethoxylated, | Lion Chemical | c) |
| | | end-capped Methyl | | |
| Lucramul CO08 | 61791-12-6 | Castor oil ethoxylate 8EO | Levaco | a) |
| Lucramul HOT 5902 | 64366-70-7 | Alcohol propoxylate-ethoxylate | Levaco | c) |
| Lucramul L03 | 68213-23-0 | C12-C18 ethoxyated alcohols, 3EO | Levaco | c) |
| Lucramul L05 | 68213-23-0 | C12-C18 ethoxyated alcohols, 5EO | Levaco | c) |
| Lutensol AO3 | 157627-86-6 | C13-15-branched and linear | BASF | c) |
| | | ethoxylated alcohols, 3EO | | |
| Lutensol AO7 | 157627-86-7 | C13-15-branched and linear | BASF | c) |
| | | ethoxylated alcohols, 7EO | | |
| Methoxy triglycol | 112-35-6 | Triethylenglycol monomethyl ether | Sigma-Aldrich | — |
| n-Butyldiglycolacetat | 112-15-2 | 2-(2-Ethoxyethoxy)ethyl acetate; | Sigma-Aldrich | c) |
| | | Diethylene glycol monoethyl ether | | |
| | | acetate | | |
| Pluriol E300 | 25322-68-3 | Polyethylenglycol- 300 | BASF | c) |
| Propylcellosolve | 2807-30-9 | Ethylenglycolmonopropylether | Sigma-Aldrich | |
| Propylenglycol Diacetat | 623-84-7 | | Sigma-Aldrich | c) |
| Radiasurf 7402 | | Polyethyleneglycol-200 monooleate | Oleon | c) |
| Radiasurf 7403 | 9004-96-0 | Polyethyleneglycol-400 monooleate | Oleon | c) |
| Radiasurf 7423 | 9004-81-3 | Polyethyleneglycol-400 monolaurate | Oleon | c) |
| Radiasurf 7442 | 9005-07-6 | Polyethyleneglycol-400 dioleate | Oleon | c) |
| Synperonic PE/L 44 | | Block-Copolymer, 40% EO, MW | Croda | b) |
| | | ~2200 g/mol | | |
| Synperonic PE/L 62 | | Block-Copolymer, 20% EO, MW | Croda | b) |
| | | ~2500 g/mol | | |
| Synperonic PE/L 64 | | Block-Copolymer, 40% EO, MW | Croda | b) |
| | | ~2900 g/mol | | |
| Triethylenglycol- | 143-22-6 | Triethylenglycol-monobutylether | Aldrich | c) |
| monobutylether | | | | |
| Tetraglyme | 143-24-8 | Tetraethylenglycol diether | Sigma-Aldrich | c) |
| Tween 20 | 9005-64-5 | ethoxylated sorbitol monolaurate, | Croda | c) |
| | | 20EO | | |
| Tween 80 | 9005-65-6 | ethoxylated sorbitol monooleate, | Croda | c) |
| | | 20EO | | |
| Tween 85 | 9005-70-3 | ethoxylated sorbitol trioleate, 20EO | Croda | c) |

The liquid preparation according to the invention may further comprise at least one substance selected from the group of surfactants, rheology modifiers, antifoaming agents, antioxidants and dyes.

Non-ionic and/or anionic surfactants are all substances of this type which can customarily be employed in agrochemical agents. Possible nonionic surfactants are selected from the groups of polyethylene oxide-polypropylene oxide block copolymers, ethoxylated mono-, di- and/or triglycerides where ethoxylated castor oil or ethoxylated vegetable oils may be mentioned by way of example, polyethylene glycol ethers of branched or linear alcohols, reaction products of fatty acids or fatty acid alcohols with ethylene oxide and/or propylene oxide, furthermore branched or linear alkylaryl ethoxylates, where polyethylene oxide-sorbitan fatty acid esters may be mentioned by way of example. Out of the examples mentioned above selected classes can be optionally phosphated and neutralized with bases. Possible anionic surfactants are all substances of this type which can customarily be employed in agrochemical agents. Alkali metal, alkaline earth metal and ammonium salts of alkylsulphonic or alkylphosphoric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalenesulphonic acid-formaldehyde condensation products, salts of condensation products of naphthalenesulphonic acid, phenolsulphonic acid and formaldehyde, and salts of lignosulphonic acid. A further preferred group of anionic surfactants or dispersing aids are alkali metal, alkaline earth metal and ammonium salts of sarcosinates or taurates. Suitable ranges of surfactants in the liquid preparation according to the invention comprise 0-20%, preferably 0-15%, more preferably 0.5-10%.

Rheology modifiers, also known as thickener, anti-caking agent, viscosity modifier or structuring agent, may be added to the present formulation, e.g. in order to prevent (irreversible) sedimentation. Rheology modifiers are preferably derived from minerals. These rheological control agents provide long term stability when the formulation is at rest or in storage. Suitable compounds are rheological modifier selected from the group consisting of hydrophobic and hydrophilic fumed and precipitated silica particles, gelling clays including bentonite, hectorite, laponite, attapulgite, sepiolite, smectite, or hydrophobically/organophilic modified bentonite. Suitable ranges of rheology modifier in the liquid preparation according to the invention comprise 0-10%, preferably 0-7%, more preferably 0.5-5%.

As far as not otherwise defined, % in the present application refers to wt.-%.

In order to disperse silicas or clay thickeners in a given fluid high shear mixing is desirable to form a gel as it is known in the art.

In a more preferred embodiment, said rheology modifier is fumed silica or precipitated silica Fumed silica, also known as pyrogenic silica, either hydrophilic or hydrophobic, usually is composed of amorphous silica fused into branched, chainlike, three-dimensional secondary particles which then agglomerate into tertiary particles. The resulting powder has an extremely low bulk density and high surface area. Both hydrophilic and hydrophobic fumed silica can be used in the present invention Fumed silica usually has a very strong thickening effect. The primary particle size is ca. 5-50 nm. The particles are non-porous and have a surface area of ca. 50-600 m²/g.

Hydrophilic fumed silica is made from flame pyrolysis of silicon tetrachloride or from quartz sand vaporized in a 3000° C. electric arc. Major global producers are Evonik Industries, tradename AEROSIL®); Cabot Corporation, tradename Cab-O-Sil®; Wacker Chemie, HDK product range; and OCI, tradename Konasil®.

Hydrophilic fumed silica can be hydrophobized by further treatment with reactive silicium-containing agents in order to modify the physicochemical properties of the silica. Typically, hydrophobisation takes place by treatment of a hydrophilic fumed silica with agents like hexaalkyldisilanes (e.g. ((CH₃)₃Si)₂), trialkylsilylchlorides (e.g. (CH₃)₃SiCl) or dialkyldichlorsilanes (e.g. (CH₃)₂SiCl₂). Hydrophobized fumed silica is available e.g. from Evonik Industries (AEROSIL R-types), and Cabot (Cab-O-Sil).

Best results are obtained using a hydrophilic fumed silica having a BET surface area of 150 to 350 m²/g, e. g. 150, 200, 250, 300 or 350.

Precipitated silica is produced by acidifying aqueous alkaline silicate solutions with mineral acids. Variations of the precipitation process lead to different precipitated silica qualities namely with different specific surface areas. The precipitates are washed and dried. Precipitated silica having a particle size of below 10 μm are most effective for the present invention. The specific surface area is typically from ca. 50-500 m²/g. Global producers are for example Evonik Industries, tradename SIPERNAT® or Wessalon®; Rhodia, tradename Tixosil®; and PPG Industries, tradename Hi-Sil™.

In a preferred embodiment the silica concentration is between 0.1 to 9 wt.-%, e. g. of 3 to 7 or 4 to 6 wt.-%. In one preferred embodiment, e.g. where spores of Trichoderma spp. are used, the silica concentration is at least 2.5 wt.-%. Alternatively, it may range between 5 and 7 wt.-%. In particular, the silica concentration may be at least 0.1 wt.-%, at least 0.2 wt.-%, at least 0.5 wt.-%, at least 1 wt.-%, at least 1.5 wt.-%, at least 2 wt.-%, at least 2.5 wt.-%, at least 3 wt.-%, at least 4 wt.-%, at least 4.5 wt.-% at least 5 wt.-%, at least 5.5 wt.-%, at least 6 wt.-%, at least 6.5 wt.-%, at least 7 wt.-%, at least 7.5 wt.-%, at least 8 wt.-%, at least 8.5 wt.-% or at least 9 wt.-% as well as any specific of the foregoing values and essentially depends on the physical properties of the biological control agent as well as those of the carrier. In general, the silica concentration in the formulation according to the invention may also depend on the biological control agent, e.g. on the size of the fungal spores. Bigger spores are believed to necessitate less silica in order to prevent sedimentation.

Major global producers for fumed (pyrogenic) hydrophilic or hydrophbized silicas are Evonik (tradename Aerosil®), Cabot Corporation (tradename Cab-O-Sil®), Wacker Chemie (HDK product range), Dow Corning, and OCI (Konasil®). Another class of suitable rheology modifiers are precipitated silicas, and major global producers are Evonik (tradenames Sipernat® or Wessalon®), Rhodia (Tixosil) and PPG Industries (Hi-Sil).

Another class of suitable examples for rheology modifiers are clay thickeners. Clay thickeners are generally micronized layered silicates that can be effective thickeners for a wide range of applications. They are typically employed either in their non-hydrophobized or hydrophobized form. In order to make them dispersible in non-aqueous solvents, the clay surface is usually treated with quaternary ammonium salts. These modified clays are known as organo-modified clay thickeners. Optionally, small amounts of alcohols of low molecular weight or water may be employed as activators. Examples for such clay-based rheology modifiers include smectite, bentonite, hectorite, attapulgite, seipiolite or montmorillonite clays. Preferred rheological modifiers (b) are for example organically modified hectorite clays such as Bentone® 38 and SD3. organically modified bentonite clays, such as Bentone® 34, SD1 and SD2, organically modified sepiolite such as Pangel® B20, hydrophilic silica such as Aerosil® 200, hydrophobic silica such as Aerosil® R972, R974 and R812S, attapulgite such as Attagel® 50,

Another class of suitable examples for rheology modifiers are organic rheological modifiers based on modified hydrogentated castor oil (trihydroxystearin) or castor oil organic derivatives such as Thixcin® R and Thixatrol® ST.

Physical properties of selected rheology modifiers:

| Tradename | Company | General description | Physical propeties | CAS-No. |
|---|---|---|---|---|
| Bentone ® 38 | Elementis | Organic derivative of a | Density: 1.7 g/cm³ | 12001-31-9 |
| | Specialties, US | hectorite clay | | |
| Bentone ® SD-3 | Elementis | Organic derivative of a | Density: 1.6 g/cm³ | |
| | Specialties, US | hectorite clay | Particle size | |
| | | | (dispersed): <1 μm | |
| Bentone ® 34 | Elementis | Organic derivative of a | Density: 1.7 g/cm³ | 68953-58-2 |
| | Specialties, US | bentonite clay | | |
| Bentone ® SD-1 | Elementis | Organic derivative of a | Density: 1.47 g/cm³ | 89749-77-9 |
| | Specialties, US | bentonite clay | | |
| Bentone ® SD-2 | Elementis | Organic derivative of a | Density: 1.62 g/cm³ | 89749-78-0 |
| | Specialties, US | bentonite clay | | |
| Pangel ® B20 | Tolsa S.A., ES | Organically modified | | 63800-37-3 |
| | | sepiolite | | |
| Sipernat ® 22 S | Evonik | Precipitated amorphous | *BET: 190 m²/g | 112926-00-8 |
| | Industries AG, | silicon dioxide | Average primary | |
| | DE | | particle size: 12 nm | |
| Aerosil ® 200 | Evonik | Hydrophilic fumed | *BET: 200 m²/g | 112945-52- |
| | Industries AG, | silica | Average primary | 57631-86-9 |
| | DE | | particle size: 12 nm | |
| Aerosil ® R 972/ | Evonik | Hydrophilic fumed | *BET: 90-130 m²/g | 68611-44-9 |
| R972V | Industries AG, | silica | | |
| | DE | | | |
| Aerosil ® R 974 | Evonik | Hydrophilic fumed | *BET: 150-190 m²/g | 68611-44-9 |
| | Industries AG, | silica | | |
| | DE | | | |
| Aerosil ® R812S | Evonik | Hydrophilic fumed | *BET: 260 ± 30 m²/g | 68909-20-6 |
| | Industries AG, | silica | | |
| | DE | | | |
| Attagel ® 50 | BASF AG, DE | Attapulgite clay: | Density: >1.0 g/cm³ | 14808-60-7 |
| | | (Mg, Al)₅Si₈O₂₀•4H₂O | Average particle | |
| | | | size: 9 μm | |
| Thixcin ® R | Elementis | organic derivative of | Density: 1.02 g/cm³ | 38264-86-7 |
| | Specialties, US | castor oil | | |
| Thixatrol ® ST | Elementis | organic derivative of | Density: 1.02 g/cm³ | 51796-19-1 |
| | Specialties, US | castor oil, | | |
| | | Octadecanamide | | |

Other commonly used rheology modifiers are polymeric rheology modifiers, such as cellulose derivatives, xanthan and polyacrylates. Examples of cellulose rheology modifiers include hydroxypropyl cellulose of different molecular weight (e.g., Klucel® H, G, L, E). Examples of xanthan rheology modifiers include medium to larger molecular weight naturally-drived xanthan polymers with or without modification (e.g., Kelzan® CC or Kelzan® S). Example of polyacrylate-based rheology modifiers are the medium to larger molecular weight polyacrylates or its (or for example, partially-hydrolyzed polyacrylamide) with or without modifications (e.g., HySorb®).

In a preferred embodiment the concentration of rheological control agent is in the range of 0 to 10% wt, e. g. of 1 to 7 or 3 to 6% wt. In particular, the concentration of rheological control agent may be 0, 0.5, 1, 1.5, 2, 2.5, 3, 4, 5, 6, 7, 8 or 9% wt and essentially depends on the physical properties of the biological control agent as well as those of the carrier liquid. In general, the concentration of rheological control agent in the formulation according to the invention may also depend on the biological control agent.

Antifoaming agents may be added to the present formulation in order to prevent foaming upon dilution with water. Suitable antifoaming agents are e.g. paraffinic oils, vegetable oils, silicone oils (e.g. Silcolapse 411, Silcolapse 454, Silcolapse 482 from Solvay; Silfoam SC1132, Silfoam SC132 from Wacker; Xiameter ACP-0100 from Dow) or aqueous silicone oil emulsions (e.g. SAG30, SAG 1572/Momentive, Silcolapse 426R, Silcolapse 432/Solvay; Silfar SE4/Wacker; Antifoam 8830/Harcros Chemicals). In a preferred embodiment the concentration of antifoaming agents is in the range of 0 to 0.5% wt, e. g. of 0.1 to 0.3% wt. In particular, the concentration of antifoaming agent may be 0, 0.1, 0.2, 0.3, 0.4 or 0.5% wt or any value in between.

Antioxidants may be added to the present formulation in order to prevent or slow down oxidative degradation processes. Suitable antioxidants are e.g. tert.-Butylhydroxyquinone (TBHQ), butylhydroxytoluol (BHT), butylhydroxyanisole (BHA), ascorbyl palmitate, tocopheryl acetate, ascorbyl stearate or the group of carotinoids (e.g. beta-carotin) or gallates (e.g. ethyl gallate, propyl gallate, octyl gallate, dodecyl gallate). In a preferred embodiment the concentration of antioxidants is in the range of 0 to 0.5% wt, e. g. of 0.1 to 0.3% wt. In particular, the concentration of antioxidants may be 0, 0.1, 0.2, 0.3, 0.4 or 0.5% wt or any value in between.

Dyes which may be used include inorganic pigments, examples being iron oxide, titanium oxide and Prussian Blue, and organic dyes, such as alizarin dyes, azo dyes and metal phthalocyanine dyes.

In a preferred embodiment, the liquid composition according to the present invention is essentially free of water. Fungal microorganisms are living organisms which have a dormant form. Accordingly, formulations comprising a low concentration of water or even being essentially free of water are a preferred formulation type for fungal microorganisms. On the other hand, certain fungal microorganisms may also be formulated in higher water contents. If water is present, such water mainly comes from residual free water in the dried spore powder or traces of water in the other formulants. Accordingly, water concentrations of between 0 and 12 wt.-%, preferably 0 and 8 wt.-% are possible due to these facts, which range would then fall within the definition of “essentially free of water”. In other words, the term “essentially free of water” refers to a concentration of water in the composition of 12% or less, preferably 8 wt.-% or less. More preferably, the water concentration ranges between 0 and 6%, more preferably between 0 and 4% such as between 2 and 4 wt.-%. Accordingly, exemplary water concentrations include 2 wt.-%, 3 wt.-%, 4 wt.-%, 5 wt.-% and 6 wt.-%.

Whereas it is believed that in the liquid preparation according to the invention said carrier such as an ethoxylated and/or propoxylated organic liquid or a carboxylic ester may be present in lower amount, such as at least 40 wt.-%, it is preferred that it is present in an amount of at least 50 wt.-%. Generally, said ethoxylated and/or propoxylated organic liquid may be present in a concentration of up to 99.9 wt.-%, preferably in a range of between 70 wt.-% and 97.5 wt.-%, more preferably between 75 wt.-% and 95 wt.-%, most preferably between 80 wt.-% and 90 wt.-%.

The liquid preparation according to the invention is preferably water-miscible. The term “water-miscible” indicates that said liquids are resulting in a homogeneous mixture if combined in a ratio of 1:200 of fluid and water, preferably in a ratio of 1:100, more preferably in a ratio of 1:50.

In a further aspect, the present invention relates to a seed coated with the liquid composition according to the invention.

In another aspect, the present invention relates to a method of increasing the germination rate of spores of a fungal microorganism comprising the steps of providing non-dried fungal spores, adding at least at least one glycerophospholipid in a weight ratio of between 10:1 and 1:5000, drying the resulting mixture and mixing it with at least one carrier In connection with the present invention, an “increased germination rate” refers to a germination rate of dormant fungal structures or organs, preferably fungal spores, which is at least 10% higher than that of dormant fungal structures or organs, such as spores not treated according to the procedure of the present invention but treated equally otherwise (“control spores”), preferably at least 20%, more preferably at least 30% or at least 40% and most preferably at least 50% higher until at least 2 weeks after production of said spores, that is after finishing the cooling period. In other words, “increased germination rate” means a germination rate of at least 110% of that of control spores, preferably at least 120%, more preferably at least 130% or at least 140% and most preferably at least 150% or higher until at least 2 weeks after production of said spores. Preferably, said increased germination rate is still visible or even increased until at least 3 months after production, more preferably at least 4 months and most preferably at least 6 months after production, such as at least 8 months, at least 10 months or even 12 months or more. Accordingly, it is preferred that the germination rate of spores treated according to the invention is at least 200% of that of control spores 3 months after production of said spores. In another preferred embodiment, the germination rate is at least 300% or at least 400%, most preferably at least 500% of that of control spores 6 months after production of said spores. The germination rate in this connection denotes the ability of spores to still germinate after a given time. % germination rate accordingly means the percentage of spores which is able to germinate after a given time. Methods of measuring the germination rate are well-known in the art. For example, spores are spread onto the surface of an agar medium, and the proportion of spores developing germ tubes is determined microscopically after incubation at appropriate growth temperatures (Oliveira et al., 2015. A protocol for determination of conidial viability of the fungal entomopathogens Beauveria bassiana and Metarhizium anisopliae from commercial products. Journal of Microbiological Methods 119; pp: 44-52, and references therein).

The liquid preparation according to the present invention may be applied in any desired manner, such as in the form of a seed coating, soil drench, and/or directly in-furrow and/or as a foliar spray and applied either pre-emergence, post-emergence or both by techniques commonly known in the art, including drone application. In other words, the liquid preparation can be applied to the seed, the plant or to harvested fruits and vegetables or to the soil wherein the plant is growing or wherein it is desired to grow (plant's locus of growth). Customary application methods include for example dipping, spraying, atomizing, irrigating, evaporating, dusting, fogging, broadcasting, foaming, painting, spreading-on, watering (drenching) and drip irrigating.

All plants and plant parts can be treated in accordance with the invention. Plants mean all plants and plant populations, such as desired and undesired wild plants or crop plants (including naturally occurring crop plants). Crop plants may be plants which can be obtained by conventional breeding and optimization methods or by biotechnological and genetic engineering methods or combinations of these methods, including the genetically modified plants (GMO or transgenic plants) and the plant cultivars which are protectable and non-protectable by plant breeders' rights.

Plant parts are understood to mean all parts and organs of plants above and below the ground, such as shoots, leaves, needles, stalks, stems, flowers, fruit bodies, fruits, seeds, roots, tubers and rhizomes. The plant parts also include harvested material and vegetative and generative propagation material, for example cuttings, tubers, rhizomes, slips and seeds.

Plants which can be treated in accordance with the invention include the following main crop plants: maize, soya bean, alfalfa, cotton, sunflower, Brassica oil seeds such as Brassica napus (e.g. canola, rapeseed), Brassica rapa, B. juncea (e.g. (field) mustard) and Brassica carinata, Arecaceae sp. (e.g. oilpalm, coconut), rice, wheat, sugar beet, sugar cane, oats, rye, barley, millet and sorghum, triticale, flax, nuts, grapes and vine and various fruit and vegetables from various botanic taxa, e.g. Rosaceae sp. (e.g. pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g. olive tree), Actinidaceae sp., Lauraceae sp. (e.g. avocado, cinnamon, camphor), Musaceae sp. (e.g. banana trees and plantations), Rubiaceae sp. (e.g. coffee), Theaceae sp. (e.g. tea), Sterculiceae sp., Rutaceae sp. (e.g. lemons, oranges, mandarins and grapefruit); Solanaceae sp. (e.g. tomatoes, potatoes, peppers, capsicum, aubergines, tobacco), Liliaceae sp., Compositae sp. (e.g. lettuce, artichokes and chicory—including root chicory, endive or common chicory), Umbelliferae sp. (e.g. carrots, parsley, celery and celeriac), Cucurbitaceae sp. (e.g. cucumbers—including gherkins, pumpkins, watermelons, calabashes and melons), Alliaceae sp. (e.g. leeks and onions), Cruciferae sp. (e.g. white cabbage, red cabbage, broccoli, cauliflower, Brussels sprouts, pak choi, kohlrabi, radishes, horseradish, cress and chinese cabbage), Leguminosae sp. (e.g. peanuts, peas, lentils and beans—e.g. common beans and broad beans), Chenopodiaceae sp. (e.g. Swiss chard, fodder beet, spinach, beetroot), Linaceae sp. (e.g. hemp), Cannabeacea sp. (e.g. cannabis), Malvaceae sp. (e.g. okra, cocoa), Papaveraceae (e.g. poppy), Asparagaceae (e.g. asparagus); useful plants and ornamental plants in the garden and woods including turf, lawn, grass and Stevia rebaudiana; and in each case genetically modified types of these plants.

Crop plants can be plants which can be obtained by conventional breeding and optimization methods or by biotechnological and genetic engineering methods or combinations of these methods, including the transgenic plants and including the plant varieties which can or cannot be protected by varietal property rights. Plants should be understood to mean all developmental stages, such as seeds, seedlings, young (immature) plants up to mature plants. Plant parts should be understood to mean all parts and organs of the plants above and below ground, such as shoot, leaf, flower and root, examples given being leaves, needles, stalks, stems, flowers, fruit bodies, fruits and seeds, and also tubers, roots and rhizomes. Parts of plants also include harvested plants or harvested plant parts and vegetative and generative propagation material, for example seedlings, tubers, rhizomes, cuttings and seeds.

Treatment according to the invention of the plants and plant parts with the liquid preparation or the composition comprising said liquid preparation is carried out directly or by allowing the compounds to act on the surroundings, environment or storage space by the customary treatment methods, for example by immersion, spraying, evaporation, fogging, scattering, painting on, injection and, in the case of propagation material, in particular in the case of seeds, also by applying one or more coats.

As already mentioned above, it is possible to treat all plants and their parts according to the invention. In a preferred embodiment, wild plant species and plant cultivars, or those obtained by conventional biological breeding methods, such as crossing or protoplast fusion, and also parts thereof, are treated. In a further preferred embodiment, transgenic plants and plant cultivars obtained by genetic engineering methods, if appropriate in combination with conventional methods (genetically modified organisms), and parts thereof are treated. The terms “parts” or “parts of plants” or “plant parts” have been explained above. The invention is used with particular preference to treat plants of the respective commercially customary cultivars or those that are in use. Plant cultivars are to be understood as meaning plants having new properties (“traits”) and which have been obtained by conventional breeding, by mutagenesis or by recombinant DNA techniques. They can be cultivars, varieties, bio- or genotypes.

Transgenic plants or plant cultivars (those obtained by genetic engineering) which are to be treated with preference in accordance with the invention include all plants which, through the genetic modification, received genetic material which imparts particular advantageous useful properties (“traits”) to these plants. Examples of such properties are better plant growth, increased tolerance to high or low temperatures, increased tolerance to drought or to levels of water or soil salinity, enhanced flowering performance, easier harvesting, accelerated ripening, higher yields, higher quality and/or a higher nutritional value of the harvested products, better storage life and/or processability of the harvested products. Further and particularly emphasized examples of such properties are increased resistance of the plants against animal and microbial pests, such as against insects, arachnids, nematodes, mites, slugs and snails owing, for example, to toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c Cry2Ab, Cry3Bb and CryIF and also combinations thereof), furthermore increased resistance of the plants against phytopathogenic fungi, bacteria and/or viruses owing, for example, to systemic acquired resistance (SAR), systemin, phytoalexins, elicitors and also resistance genes and correspondingly expressed proteins and toxins, and also increased tolerance of the plants to certain herbicidally active compounds, for example imidazolinones, sulphonylureas, glyphosate or phosphinothricin (for example the “PAT” gene). The genes which impart the desired traits in question may also be present in combinations with one another in the transgenic plants. Examples of transgenic plants which may be mentioned are the important crop plants, such as cereals (wheat, rice, triticale, barley, rye, oats), maize, soya beans, potatoes, sugar beet, sugar cane, tomatoes, peas and other types of vegetable, cotton, tobacco, oilseed rape and also fruit plants (with the fruits apples, pears, citrus fruits and grapes), with particular emphasis being given to maize, soya beans, wheat, rice, potatoes, cotton, sugar cane, tobacco and oilseed rape. Traits which are particularly emphasized are the increased resistance of the plants to insects, arachnids, nematodes and slugs and snails.

The compound and the composition of the invention may advantageously be used to protect seeds from unwanted microorganisms, such as phytopathogenic microorganisms, for instance phytopathogenic fungi or phytopathogenic oomycetes; or from plant pests such as insects or nematodes. The term seed(s) as used herein include dormant seeds, primed seeds, pregerminated seeds and seeds with emerged roots and leaves.

Thus, the present invention also relates to a method for protecting seeds from unwanted microorganisms which comprises the step of treating the seeds with the liquid composition of the invention.

The treatment of seeds with the liquid composition of the invention protects the seeds, but also protects the germinating seeds, the emerging seedlings and the plants after emergence from the treated seeds.

Therefore, the present invention also relates to a method for protecting seeds, germinating seeds and emerging seedlings.

The seeds treatment may be performed prior to sowing, at the time of sowing or shortly thereafter.

When the seeds treatment is performed prior to sowing (e.g. so-called on-seed applications), the seeds treatment may be performed as follows: the seeds may be placed into a mixer with a desired amount of the liquid composition of the invention, the seeds and the liquid composition of the invention are mixed until an homogeneous distribution on seeds is achieved. If appropriate, the seeds may then be dried.

The invention also relates to seeds coated with the liquid composition of the invention.

Preferably, the seeds are treated in a state in which it is sufficiently stable for no damage to occur in the course of treatment. In general, seeds can be treated at any time between harvest and shortly after sowing. It is customary to use seeds which have been separated from the plant and freed from cobs, shells, stalks, coats, hairs or the flesh of the fruits. For example, it is possible to use seeds which have been harvested, cleaned and dried down to a moisture content of less than 15% by weight. Alternatively, it is also possible to use seeds which, after drying, for example, have been treated with water and then dried again, or seeds just after priming, or seeds stored in primed conditions or pre-germinated seeds, or seeds sown on nursery trays, tapes or paper.

The amount of the liquid composition of the invention applied to the seeds is typically such that the germination of the seed is not impaired, or that the resulting plant is not damaged. This must be ensured particularly in case the compound of the invention would exhibit phytotoxic effects at certain application rates. The intrinsic phenotypes of transgenic plants should also be taken into consideration when determining the amount of the liquid composition of the invention to be applied to the seed in order to achieve optimum seed and germinating plant protection with a minimum amount of composition being employed.

The preparation of the invention can be applied as such, directly to the seeds, i.e. without the use of any other components and without having been diluted. Also, the composition of the invention can be applied to the seeds.

The preparation and the liquid composition of the invention are suitable for protecting seeds of any plant variety. Preferred seeds are that of cereals (such as wheat, barley, rye, millet, triticale, and oats), oilseed rape, maize, cotton, soybean, rice, potatoes, sunflower, beans, coffee, peas, beet (e.g. sugar beet and fodder beet), peanut, vegetables (such as tomato, cucumber, onions and lettuce), lawns and ornamental plants. More preferred are seeds of wheat, soybean, oilseed rape, maize and rice.

The preparation and the composition of the invention may be used for treating transgenic seeds, in particular seeds of plants capable of expressing a polypeptide or protein which acts against pests, herbicidal damage or abiotic stress, thereby increasing the protective effect. Seeds of plants capable of expressing a polypeptide or protein which acts against pests, herbicidal damage or abiotic stress may contain at least one heterologous gene which allows the expression of said polypeptide or protein. These heterologous genes in transgenic seeds may originate, for example, from microorganisms of the species Bacillus, Rhizobium, Pseudomonas, Serratia, Trichoderma, Clavibacter, Glomus or Gliocladium. These heterologous genes preferably originate from Bacillus sp., in which case the gene product is effective against the European corn borer and/or the Western corn rootworm. Particularly preferably, the heterologous genes originate from Bacillus thuringiensis.

The preparation or the liquid composition of the invention can be applied as such, or for example in the form of as ready-to-use solutions, emulsions, water- or oil-based suspensions, powders, wettable powders, pastes, soluble powders, dusts, soluble granules, granules for broadcasting, suspoemulsion concentrates, natural products impregnated with the compound of the invention, synthetic substances impregnated with the compound of the invention, fertilizers or microencapsulations in polymeric substances.

Application is accomplished in a customary manner, for example by watering, spraying, atomizing, broadcasting, dusting, foaming or spreading-on. It is also possible to deploy the compound of the invention by the ultra-low volume method, via a drip irrigation system or drench application, to apply it in-furrow or to inject it into the soil stem or trunk. It is further possible to apply the compound of the invention by means of a wound seal, paint or other wound dressing.

The effective and plant-compatible amount of the compound of the invention which is applied to the plants, plant parts, fruits, seeds or soil will depend on various factors, such as the compound/composition employed, the subject of the treatment (plant, plant part, fruit, seed or soil), the type of treatment (dusting, spraying, seed dressing), the purpose of the treatment (curative and protective), the type of microorganisms, the development stage of the microorganisms, the sensitivity of the microorganisms, the crop growth stage and the environmental conditions.

When the preparation or liquid composition of the invention is applied, rates can vary within a relatively wide range, depending on the kind of application. For the treatment of plant parts, such as leaves, the application rate may range from 0.1 to 10 000 g/ha, preferably from 10 to 1000 g/ha, more preferably from 50 to 300 g/ha (in the case of application by watering or dripping, it is even possible to reduce the application rate, especially when inert substrates such as rockwool or perlite are used). For the treatment of seeds, the application rate may range from 0.1 to 200 g per 100 kg of seeds, preferably from 1 to 150 g per 100 kg of seeds, more preferably from 2.5 to 25 g per 100 kg of seeds, even more preferably from 2.5 to 12.5 g per 100 kg of seeds. For the treatment of soil, the application rate may range from 0.1 to 10 000 g/ha, preferably from 1 to 5000 g/ha.

In yet another preferred embodiment said fungal spores are present in the formulation according to the invention in a concentration of between at least about 1×10⁵/ml and about 2×10¹/ml, such as 1×10⁶/ml, 1×10⁷/ml, 1×10⁸/ml. Chlamydospores may be present in a concentration of between about 1×10⁶/ml and about 1×10⁹/ml.

Accordingly, fungal spores may be present in a concentration of e.g. about 1×10⁷/ml, 1×10⁸/ml, 5×10⁸/ml, 1×10⁹/ml, 5×10⁹/ml, 1×10¹⁰/ml, 5×10¹⁰/ml, 1×10¹¹/ml or 1.5×10¹¹/ml, all depending on the requirements of the application. Chlamydospores may be present in a concentration of e.g. about 5×10⁶/ml, 1×10⁷/ml, 5×10⁷/ml, 1×10⁸/ml or 5×10⁸/ml, all depending on the requirements of the application.

Depending on the size of the spores used and the desired spore concentration in the composition, different amounts of spore powder need to be used. Exemplary percentages range from 0.5 wt.-% to 40 wt.-%, such as about 3 wt.-%, about 5 wt.-%, about 7 wt.-%, about 10 wt.-%, about 15 wt.-%, about 20 wt.-%, about 25 wt.-%, about 30 wt.-%, about 35 wt.-% or about 40 wt.-%.

For seed treatment application, usually the preparation or liquid composition is applied to result in between 1×10³ and 1×10⁸ cfu/seed, preferably between 1×10⁴ and 1×10⁷ cfu/seed and any value in between.

When applied to soil, usual application rates result in between 1×10⁸ and 1×10¹³ cfu/ha, preferably between 1×10⁹ and 1×10² cfu/ha, more preferably between 1×10¹⁰ and 1×10¹² cfu/ha or any value in between; or between 1×10⁴ and 1×10⁷ cfu/g of soil.

In one preferred embodiment, the seed treated according to the invention further comprises at least one further plant protection agent. Basically, any suitable plant protection agent used in the treatment of seeds may be used. These include prothioconazole, metalaxyl, mefenoxam, fluoxastrobin, tebuconazole, ipconazole, metconazole, cyproconazole, epoxiconazole, propiconazole, azoxystrobin, pyraclostrobin, picoxystrobin, benzovindiflupyr, fluxapyroxad and chlorothalonil.

The invention also relates to a method of producing a preparation according to the present invention, comprising the steps of providing non-dried fungal spores, adding at least at least one glycerophospholipid in a weight ratio of between 10:1 and 1:5000 and drying the resulting mixture.

Equally comprised by the present invention is a method of producing a composition according to the invention, comprising the steps of providing non-dried fungal spores, adding at least at least one glycerophospholipid in a weight ratio of between 10:1 and 1:5000, drying the resulting mixture and mixing it with at least one carrier

Methods for preparing dried spores are well known in the art and include fluidized bed drying, spray drying, vacuum drying, vacuum drum drying, air-drying and lyophilization. Conidia may be dried in 2 steps: For conidia produced by solid-state fermentation, the conidia covered culture substrate may either be dried before harvesting the conidia from the dried culture substrate thereby obtaining a pure conidia powder. Then the preparation according to the invention is produced and then the spores in the preparation are dried further using e.g. air drying or spray-drying.

Alternatively, the fungal spores may be harvested from the culture substrate by flushing with water. The resulting slurry may then be mixed with at least one glycerophospholipid according to the invention. For example, in case of a Solid-State Fermentation, the spores and the culture substrate are both in solid form. In this case, the spores can be removed from the substrate using a solution of e.g. lecithin and/or the spores that are removed from the substrate can then be mixed with a solution of e.g. lecithin. Drying spores without a glycerophospholipid such as lecithin will lead to a certain loss in germination, while this is not the case when e.g. lecithin is added during the drying stage. Also, as an example for liquid fermentation, for example lecithin can be added to the fermentation broth or any derivate of it, which upon removal of water will lead to improved germination of the dried spores and/or formulations of. This enables a process where a more purified and solid spore concentration can be produced. At the same time using a glycerophospholipid such as lecithin enables improved germination and therefore quality for the spores and the final products.

The present invention also relates to a method of controlling phytopathogenic fungi, insects, spiders, molluscs, weeds, and/or nematodes in a plant or plant part, for enhancing growth of a plant or for increasing plant yield or root health comprising applying the preparation according to the invention or the liquid composition according to the invention to said plant or plant part or to a plot where plants are to be grown. Accordingly, the invention also relates to the use of a preparation according to any one of claims 1 to 7 or a liquid composition according to any one of claims 8 to 13 for controlling phytopathogenic fungi, insects, spiders, molluscs, weeds, rodents and/or nematodes in, on or around a plant or plant part, for enhancing growth of a plant or for increasing plant yield or root health. Preferably, said preparation or liquid composition is applied to seed.

The present invention also relates to the use of at least one glycerophospholipid as described herein for increasing the germination rate of spores of a fungal microorganism.

Further, the present invention relates to the use of at least one glycerophospholipid for stabilizing spores of fungal microorganisms, preferably those obtained with wet-harvest.

The following examples illustrate the invention in a non-limiting fashion:

### Materials and Methods

The spores of Trichoderma strains T1 and B35 were prepared by Solid State Fermentation (SSF) and harvested, then centrifuged to form a spore paste. T1 is used here as an abbreviation for Trichoderma atroviride strain T1 with a culture collection No. I123-7 (French collection), while B35 is used here as an abbreviation for Trichoderma asperellum strain B35, deposited in the German Culture collection under the No. DSM33245.

For the air-drying experiments (explained further below), in order to get a protectant-to-spore mass ratio of 1:1 (except for lecithin), 12 g of the spore paste was mixed with 3 g of the protectant in order to get a total of 15 g. The spore concentration in the paste is about 25%, which makes then 3 g of spore in contact with 3 g of protectant. The mixture of protectants and paste were mixed for 5 min and 3400 rpm using an Ultra-Turrax equipment (IKA T25). In case of the test for lecithin, 1.5 g of a 20% lecithin solution was added to 13.5 g of spore paste, then mixed according to the afore-mentioned procedure (5 min, 3400 rpm). After mixing, the mixture was poured into a tray and dried at room temperature overnight. The materials used are summarized in Table 1.

For all experiments conducted, dry matter content (as related to total moisture content) was measured by a heating balance apparatus (Sartorius MA 160).

Germination rates were measured according to the following protocol: The sample with the spores is dispersed in sterile tap water to get a homogenous spore solution. Depending on the initial spore concentration, the sample may need to be diluted up to 1E+07 spores/mL. This dilution then is spread on agar plates (often, 100 μl of dilution spread on a Potato Dextrose Agar plate) with a sterile Drigalski spatula. Depending on the strain type, the plates are incubated at a certain temperature (for example 20° C. for Trichoderma used here) for some time (here 19-24 hours is used) to allow time for germination and forming hyphae. Subsequently, the spores on the plates are analyzed under the microscope in 8 to 10 randomly chosen areas. At least 200 germinated and non-germinated spores are counted. The viability (%) is calculated by 100 times the number of germinated spores to the total spores counted.

For the spray-drying experiments, pilot-scale spray dryer equipment was used. A rotating perforated disk was used to create droplets, the rotation speed of which is recorded as an operating parameter. Other operating parameters are also recorded in Table 2 and 3, for example. The equipment included a tank in which the diluted spores and materials are placed. The percent concentration of the spores and stabilizer/protectant materials in this diluted solution ready to be sprayed can be an operational variable that is optimized for different strains and applications (in this case, the spore and lecithin concentration was 5% of the total diluted solution that was spray-dried). This solution is continuously stirred throughout the spray-drying operation. A feed pump injects a fixed rate (liquid feed flow of 0.6 kg/h) of this solution into the drier. The gas stream is heated to a certain temperature (operating parameter recorded in Table 2 and 3 for example). Nitrogen is used as the drying gas with a flow of 60 m³/h. Inlet gas temperature is controlled and outlet gas temperature is monitored. In this example, the equipment is equipped with two mechanisms to capture the dried solid particles after the spray-drying chamber: first a cyclone and then a filter. What is not captured by the cyclone can then be captured by the filter. The time required for spray-drying depends on the sample size.

Formulations were made by mixing the dried spores (both with and without lecithin) in different liquid carriers to result in a formulation with 97.5 wt. % carrier and 2.5% spores or spores mixed with lecithin (if rheology modifier was used, then 2% Aerosil 200 is with 2.5% lecithin-treated or -untreated spores and the rest is the carrier). In other words, one set of experiments was done without any rheology modifier, and the other set is done with 2% Aerosil 200 added to the formulation as rheology modifier. The samples were stored at 20, 25, and 30° C. over periods of time under nitrogen. For each period, a separate sample is prepared, and the respective sample is tested for germination rate of the spores at a determined time point.

### EXAMPLE 1: COMPARISON OF DIFFERENT PROTECTANT FOR TRICHODERMA SPP. STRAINS

A test was conducted to compare lecithin against other known microbial stabilizers and protectant materials. These materials include different sugars, proteins, skim milk powder, and others. Initially, an air-drying technique in room temperature was used.

After the spores were air dried with different protectants at room temperature overnight, the germination rate and total dry matter content (DMC, which is a way of expressing total moisture content) of the samples were analyzed. Table 1 shows the results for two strains of Trichoderma.

TABLE 1
Comparison of Trichoderma germination rates after air-drying with
no protectants, with conventional and theoretical stabilizers and
protectants (1:1 material:spore) vs. with lecithin (1:10 material:spore).

| | Germination rate (%) | | DMC (%) | |
|---|---|---|---|---|
| | T1 | B35 | T1 | B35 |
| no protectants | 62.21 | 74.63 | 91.05 | 90.04 |
| Yeast without AA | 15.54 | 4.69 | 91.79 | 92.52 |
| Amino Acids | | | | |
| Skim milk powder | 67.34 | 25.84 | 89.63 | 90.46 |
| Maltodextrin | 54.55 | 20.38 | 94.46 | 92.49 |
| Chitosan | not soluble | | — | — |
| Proteinshake | 41.58 | 17.76 | 92.52 | 93.02 |
| Lecithin | 74.63 | 73.56 | 95.43 | 92.88 |
| Sucrose | spores not | 36.45 | — | 91.59 |
| | processable | | | |
| Trehalose | 68.75 | 43.18 | 90.35 | 91.84 |
| Sorbitol/Glucitol | spores not | 13.00 | — | 93.99 |
| | processable | | | |
| Ducitol/Galactitol | not soluble | | — | — |
| Mannitol | 69.95 | 51.40 | 97.01 | 94.88 |
| Myo-Inositol | 65.03 | 59.05 | 96.6 | 95.59 |

As shown in Table 1, lecithin has shown superior performance in terms of maintaining the germination rate of Trichoderma strains over other tested materials in these tested conditions. In our example, the superiority of lecithin over other materials tested is more evident in the case of the more inherently sensitive strain variety B35 (Trichoderma asperellum). It is also noteworthy that Lecithin-to-spore ratio in these experiments were 1:10, while the other commonly known or theoretical stabilizers and protectants were used in material-to-spore ratio of 1:1. In other words, lecithin was used in 10 times less concentration, compared to other materials tested. These superior effects seen from lecithin are observed in this test with 10 times less concentrations compared to other fungal stabilizer and protectant materials used.

### EXAMPLE 2: COMPARISON OF PROTECTANTS AT INDUSTRIAL SCALE

At the next stage in evaluation, we wanted to also show these superior results in an example of industrially-scalable technique, such as spray-drying for example. A pilot-size spray-dryer equipment was used, as described above. Using such instrument, the effect of lecithin on the viability of two exemplary Trichoderma strain (in this case T1) was evaluated.

Tables 2 and 3 show the results and parameters used in spray-drying of the tested Trichoderma strains without stabilizer or protectant, with lecithin, and with two of the most common protectants (trehalose, and skim milk powder) used for microorganisms. The results for this example show a benefit ranging from 40-100% increase in germination rate after spray-drying with lecithin as opposed to when no protectant or stabilizer is added. More importantly, in comparison with two other widely-used protectants (trehalose and skim milk powder), it surely shows outperformance. This is in alignment with our previous experiment in example 1 in which lecithin also outperformed in increasing the germination rate of the dried spores.

TABLE 2
Comparison of Trichoderma germination rates in a pilot-scale spray-dryer (in presence and absence of lecithin/in
comparison with other protectants). In this study protectant-to-spore mass ratio was selected to be 1:1.

| | | Rotating | | | | | Residual | | Viability |
|---|---|---|---|---|---|---|---|---|---|
| | Solids conc | Speed | Temp | Temp | Product | Product in | moisture | Feed Viability | normalized mean |
| | in feed | Atomizer | Inlet | Outlet | in Filter | Cyclone | Cyclone | before drying | after drying |
| | w % | U/min | ° C. | ° C. | — | — | % | % | % |
| Trichoderma (Paste) + 5% | 5 | 15000 | 45 | 30 | 0% | 100% | 7.2 | 99 | 79.5 |
| lecithin | | | | | | | | | |
| Trichoderma (Paste) + 5% | 5 | 15000 | 45 | 30 | 0% | 100% | 5.67 | 99 | 78.5 |
| lecithin + 5% Trehalose | | | | | | | | | |
| Trichoderma (Paste) | 5 | 15000 | 45 | 30 | 0% | 100% | 7.72 | 99 | 39.3 |
| Trichoderma (Paste) + 5% | 5 | 15000 | 45 | 30 | 0% | 100% | 7.31 | 99 | 56.5 |
| Trehalose | | | | | | | | | |
| Trichoderma (Paste) + 5% | 5 | 15000 | 45 | 30 | 0% | 100% | 6.6 | 99 | 62.1 |
| Skim milk powder | | | | | | | | | |

TABLE 3
Repeating comparison of Trichoderma germination rates in a pilot-scale spray-dryer (in presence and absence of lecithin). In this study protectant-
to-spore mass ratio was selected to be 1:1. (Values in bracket: new determination of viability after shipment of material under unknown conditions)

| | | | Rotating | | | | | Residual | | Viability |
|---|---|---|---|---|---|---|---|---|---|---|
| | Solids conc | Process | Speed | Temp | Temp | Product | Product in | moisture | Feed Viability | normalized mean |
| | in feed | Time | Atomizer | Inlet | Outlet | in Filter | Cyclone | Cyclone | before drying | after drying |
| | w % | min | U/min | ° C. | ° C. | — | — | % | % | % |
| Trichoderma (Paste) | 3.76 | 62 | 25000 | 50 | 30 | 0% | 100% | 7.8 | 97.3 | 56.9 |
| Trichoderma (Paste) | 8.12 | 33 | 25000 | 50 | 30 | 0% | 100% | 6.82 | 97.3 | 55.6 |
| Trichoderma (Paste) | 3.6 | 95 | 15000 | 45 | 30 | 0% | 100% | 7 | 97.5 | 50.7 (41.8) |
| Trichoderma (Paste) + | 11.3 | 142 | 15000 | 45 | 30 | 0% | 100% | 4.2 | 97.5 | 68.9 (62.1) |
| 5% lecithin | | | | | | | | | | |

The spore powders a) without lecithin and a germination rate of 41.8% and the spore powder b) with lecithin (ratio 1:1) and a germination rate of 62.1% were studied during storage at 4° C. and minus 20° C. The powders were stored in closed plastic tubes and the germination rate was analyzed overtime. Lecithin showed a significant protecting effect after drying of the spores (t0), and a stabilizing effect during storage at minus 20° C. (see table 4).

TABLE 4
Germination rate over time of TI Trichoderma spore powder spray-dried
with and without lecithin. Storage conditions are 4° C. and −20° C.

| | 4° C. | | −20° C. | |
|---|---|---|---|---|
| Storage | powder | powder | powder | powder |
| time | without | with | without | with |
| (months) | lecithin | lecithin | lecithin | lecithin |
| 0 | 41.8 | 62.1 | 41.8 | 62.1 |
| 0.5 | 31.0 | 45.4 | 29.7 | 53.9 |
| 1 | 39.5 | 42.5 | 20.9 | 38.0 |
| 2 | 41.9 | 43.2 | 22.3 | 51.5 |
| 3 | 27.7 | 31.8 | 26.6 | 55.2 |
| 6 | 21.6 | 24.3 | 30.7 | 59.2 |

### EXAMPLE 3: GERMINATION RATE OF FORMULATED FUNGAL SPORES

The next stage of evaluation in this example is to determine the germination rate of spores treated with lecithin and disbursed in liquid carriers and formulations. For this reason, we selected few different example carriers and made formulations of T1 Trichoderma (both spray-dried and spray-dried with lecithin) with and without silica (Aerosil 200 from Evonik) as rheology-modifier. Such formulations were stored at different storage temperatures (20, 25, and 30° C., respectively) under Nitrogen. The germination rate of the spores in each formulation was measured over time. Tables 5-7 show the results for the samples with no silica, and Tables 8-10 show the results for samples with silica, as rheology modifier. Both groups indicate the outperformance of lecithin in combination with some liquid carriers.

TABLE 5
Comparison between germination rate of T1 Trichoderma spray-dried with and without lecithin and
then dispersed into different formulation carriers (no silica added). Storage condition is 20° C.

| | without 2% | | | | | | |
|---|---|---|---|---|---|---|---|
| | Aerosil | | | | | | |
| | (AE200) | | | | | | |
| | 20° C. | | | | | | |
| | BreakThruS240 | | Radiasurf 7403 | | Triacetin | | Atlas G5002L |
| | Spray- | Spray- | Spray- | Spray- | Spray- | Spray- | Spray- |
| | dried T1 | dried T1 | dried T1 | dried T1 | dried T1 | dried T1 | dried T1 |
| storage | without | with | without | with | without | with | without |
| time | protectant | lecithin | protectant | lecithin | protectant | lecithin | protectant |
| (months) | Germination Rate (%) | | | | | | |
| 0 | 41.81 | 62.11 | 41.81 | 62.11 | 41.81 | 62.11 | 41.81 |
| 0.5 | 27.10 | 57.51 | 37.34 | 59.03 | 8.24 | 20.02 | 43.31 |
| 1 | 16.74 | 36.57 | 27.87 | 56.68 | 6.27 | 13.76 | 24.36 |
| 1.5 | 17.65 | 37.36 | 25.66 | 58.78 | 9.09 | 9.09 | 26.86 |
| 3 | 7.25 | 35.71 | 23.96 | 53.03 | 3.32 | 10.8 | 23.97 |
| 15 | 5.48 | 8.59 | 5.48 | 24.01 | 0.99 | 2.91 | 7.41 |

| | 20° C. | | | | | | |
|---|---|---|---|---|---|---|---|
| | Atlas G5002L | Etocas 10 | | DEVTween 20 | | AgniqueAE829 | |
| | Spray- | Spray- | Spray- | Spray- | Spray- | Spray- | Spray- |
| | dried T1 | dried T1 | dried T1 | dried T1 | dried T1 | dried T1 | dried T1 |
| storage | with | without | with | without | with | without | with |
| time | lecithin | protectant | lecithin | protectant | lecithin | protectant | lecithin |
| (months) | Germination Rate (%) | | | | | | |
| 0 | 62.11 | 41.81 | 62.11 | 41.81 | 62.11 | 41.81 | 62.11 |
| 0.5 | 53.80 | 30.94 | 48.79 | 13.33 | 67.42 | 16.34 | 38.67 |
| 1 | 50.86 | 16.16 | 47.67 | 19.14 | 57.53 | 24.38 | 43.82 |
| 1.5 | 51.66 | 22.51 | 44.86 | 20.07 | 49.08 | 18.18 | 36.37 |
| 3 | 39.22 | 9.39 | 45.63 | 13.13 | 42.53 | 13.99 | 10.45 |
| 15 | 22.72 | 4.46 | 12.28 | 7.41 | 25.56 | 0 | 4.03 |

TABLE 6
Comparison between germination rate of T1 Trichoderma spray-dried with and without lecithin and
then dispersed into different formulation carriers (no silica added). Storage condition is 25° C.

| | without 2% | | | | | | |
|---|---|---|---|---|---|---|---|
| | Aerosil 200 | | | | | | |
| | (AE200) | | | | | | |
| | 25° C. | | | | | | |
| | BreakThruS240 | | Radiasurf 7403 | | Triacetin | | Atlas G5002L |
| | Spray- | Spray- | Spray- | Spray- | Spray- | Spray- | Spray- |
| | dried T1 | dried T1 | dried T1 | dried T1 | dried T1 | dried T1 | dried T1 |
| storage | without | with | without | with | without | with | without |
| time | protectant | lecithin | protectant | lecithin | protectant | lecithin | protectant |
| (months) | Germination Rate (%) | | | | | | |
| 0 | 41.81 | 62.11 | 41.81 | 62.11 | 41.81 | 62.11 | 41.81 |
| 0.5 | 26.68 | 47.22 | 33.53 | 63.64 | 7.09 | 16.97 | 36.43 |
| 1 | 17.36 | 46.93 | 24.77 | 69.09 | 7.31 | 15.65 | 34.59 |

| | 25° C. | | | | | | |
|---|---|---|---|---|---|---|---|
| | Atlas G5002L | Etocas 10 | | DEVTween 20 | | AgniqueAE829 | |
| | Spray- | Spray- | Spray- | Spray- | Spray- | Spray- | Spray- |
| | dried T1 | dried T1 | dried T1 | dried T1 | dried T1 | dried T1 | dried T1 |
| storage | with | without | with | without | with | without | with |
| time | lecithin | protectant | lecithin | protectant | lecithin | protectant | lecithin |
| (months) | Germination Rate (%) | | | | | | |
| 0 | 62.11 | 41.81 | 62.11 | 41.81 | 62.11 | 41.81 | 62.11 |
| 0.5 | 63.26 | 27.08 | 59.39 | 28.19 | 69.18 | 15.86 | 45.02 |
| 1 | 60.17 | 21.84 | 46.29 | 23.98 | 52.65 | 15.64 | 32.30 |

TABLE 7
Comparison between germination rate of T1 Trichoderma spray-dried with and without lecithin and
then dispersed into different formulation carriers (no silica added). Storage condition is 30° C.

| | without 2% | | | | | | |
|---|---|---|---|---|---|---|---|
| | Aerosil 200 | | | | | | |
| | (AE200) | | | | | | |
| | 30° C. | | | | | | |
| | BreakThruS240 | | Radiasurf 7403 | | Triacetin | | Atlas G5002L |
| | Spray- | Spray- | Spray- | Spray- | Spray- | Spray- | Spray- |
| | dried T1 | dried T1 | dried T1 | dried T1 | dried T1 | dried T1 | dried T1 |
| storage | without | with | without | with | without | with | without |
| time | protectant | lecithin | protectant | lecithin | protectant | lecithin | protectant |
| (months) | Germination Rate (%) | | | | | | |
| 0 | 41.81 | 62.11 | 41.81 | 62.11 | 41.81 | 62.11 | 41.81 |
| 0.5 | 45.02 | 57.73 | 38.71 | 74.58 | 11.88 | 23.32 | 59.85 |

| | 30° C. | | | | | | |
|---|---|---|---|---|---|---|---|
| | Atlas G5002L | Etocas 10 | | DEVTween 20 | | AgniqueAE829 | |
| | Spray- | Spray- | Spray- | Spray- | Spray- | Spray- | Spray- |
| | dried T1 | dried T1 | dried T1 | dried T1 | dried T1 | dried T1 | dried T1 |
| storage | with | without | with | without | with | without | with |
| time | lecithin | protectant | lecithin | protectant | lecithin | protectant | lecithin |
| (months) | Germination Rate (%) | | | | | | |
| 0 | 62.11 | 41.81 | 62.11 | 41.81 | 62.11 | 41.81 | 62.11 |
| 0.5 | 77.84 | 36.03 | 79.16 | 37.02 | 73.86 | 30.89 | 46.89 |

TABLE 8
Comparison between germination rate of T1 Trichoderma spray-dried with and without lecithin and then
dispersed into different formulation carriers (Aerosil 200 added). Storage condition is 20° C.

| | with 2% | | | | | | |
|---|---|---|---|---|---|---|---|
| | Aerosil 200 | | | | | | |
| | (AE200) | | | | | | |
| | 20° C. | | | | | | |
| | | | Radiasurf | | | | Atlas |
| | BreakThru245 | | 7403 + AE200 | | Triacetin + AE200 | | G5002L + AE200 |
| | Spray- | Spray- | Spray- | Spray- | Spray- | Spray- | Spray- |
| | dried T1 | dried T1 | dried T1 | dried T1 | dried T1 | dried T1 | dried T1 |
| storage | without | with | without | with | without | with | without |
| time | protectant | lecithin | protectant | lecithin | protectant | lecithin | protectant |
| (months) | Germination Rate (%) | | | | | | |
| 0 | 41.81 | 62.11 | 41.81 | 62.11 | 41.81 | 62.11 | 41.81 |
| 0.5 | 36.96 | 66.27 | 36.46 | 0? | 12.89 | 34.04 | 35.64 |
| 1 | 23.17 | 52.79 | 25.40 | 59.05 | 8.88 | 21.03 | 23.11 |
| 1.5 | 21.90 | 42.09 | 26.57 | 59.88 | 9.24 | 13.06 | 25.07 |
| 3 | 13.11 | 32.74 | 18.44 | 49.35 | 3.38 | 27.13 | 17.78 |
| 15 | 5.48 | 15.25 | 5.48 | 23.66 | 3.10 | 8.93 | 7.41 |

| | 20° C. | | | | | | |
|---|---|---|---|---|---|---|---|
| | Atlas | | | DEVTween | | | |
| | G5002L + AE200 | Etocas 10 + AE200 | | 20 + AE200 | | AgniqueAE829 + AE200 | |
| | Spray- | Spray- | Spray- | Spray- | Spray- | Spray- | Spray- |
| | dried T1 | dried T1 | dried T1 | dried T1 | dried T1 | dried T1 | dried T1 |
| storage | with | without | with | without | with | without | with |
| time | lecithin | protectant | lecithin | protectant | lecithin | protectant | lecithin |
| (months) | Germination Rate (%) | | | | | | |
| 0 | 62.11 | 41.81 | 62.11 | 41.81 | 62.11 | 41.81 | 62.11 |
| 0.5 | 71.72 | 30.42 | 57.03 | 25.49 | 62.78 | 38.85 | 35.65 |
| 1 | 48.10 | 28.82 | 45.26 | 21.08 | 54.59 | 28.61 | 39.40 |
| 1.5 | 53.17 | 23.99 | 46.47 | 20.45 | 49.78 | 21.69 | 28.29 |
| 3 | 44.9 | 13.68 | 33.72 | 9.25 | 41.21 | 18.93 | 12.11 |
| 15 | 27.01 | 2.72 | 12.13 | 3.54 | 21.47 | 2.15 | 8.93 |

TABLE 9
Comparison between germination rate of T1 Trichoderma spray-dried with and without lecithin and then
dispersed into different formulation carriers (Aerosil 200 added). Storage condition is 25° C.

| | with 2% | | | | | | |
|---|---|---|---|---|---|---|---|
| | Aerosil 200 | | | | | | |
| | (AE200) | | | | | | |
| | 25° C. | | | | | | |
| | | | Radiasurf | | | | Atlas |
| | BreakThru245 | | 7403 + AE200 | | Triacetin + AE200 | | G5002L + AE200 |
| | Spray- | Spray- | Spray- | Spray- | Spray- | Spray- | Spray- |
| | dried T1 | dried T1 | dried T1 | dried T1 | dried T1 | dried T1 | dried T1 |
| storage | without | with | without | with | without | with | without |
| time | protectant | lecithin | protectant | lecithin | protectant | lecithin | protectant |
| (months) | Germination Rate (%) | | | | | | |
| 0 | 41.81 | 62.11 | 41.81 | 62.11 | 41.81 | 62.11 | 41.81 |
| 0.5 | 34.48 | 54.81 | 30.76 | 67.74 | 17.67 | 37.07 | 39.48 |
| 1 | 25.56 | 51.10 | 23.33 | 65.86 | 10.39 | 23.61 | 28.83 |

| | 25° C. | | | | | | |
|---|---|---|---|---|---|---|---|
| | Atlas | | | DEVTween | | | |
| | G5002L + AE200 | Etocas 10 + AE200 | | 20 + AE200 | | AgniqueAE829 + AE200 | |
| | Spray- | Spray- | Spray- | Spray- | Spray- | Spray- | Spray- |
| | dried T1 | dried T1 | dried T1 | dried T1 | dried T1 | dried T1 | dried T1 |
| storage | with | without | with | without | with | without | with |
| time | lecithin | protectant | lecithin | protectant | lecithin | protectant | lecithin |
| (months) | Germination Rate (%) | | | | | | |
| 0 | 62.11 | 41.81 | 62.11 | 41.81 | 62.11 | 41.81 | 62.11 |
| 0.5 | 68.10 | 27.00 | 64.48 | 25.90 | 67.75 | 20.79 | 44.00 |
| 1 | 62.00 | 16.76 | 49.17 | 20.32 | 61.25 | 31.28 | 27.45 |

TABLE 10
Comparison between germination rate of T1 Trichoderma spray-dried
with and without lecithin and then dispersed into different formulation
carriers (Aerosil 200 added). Storage condition is 30° C.

| | with 2% | | | | | | |
|---|---|---|---|---|---|---|---|
| | Aerosil 200 | | | | | | |
| | (AE200) | | | | | | |
| | 30° C. | | | | | | |
| | BreakThruS240 | | Radiasurf 7403 | | Triacetin | | Atlas G5002L |
| | Spray- | Spray- | Spray- | Spray- | Spray- | Spray- | Spray- |
| | dried T1 | dried T1 | dried T1 | dried T1 | dried T1 | dried T1 | dried T1 |
| storage | without | with | without | with | without | with | without |
| time | protectant | lecithin | protectant | lecithin | protectant | lecithin | protectant |
| (months) | Germination Rate (%) | | | | | | |
| 0 | 41.81 | 62.11 | 41.81 | 62.11 | 41.81 | 62.11 | 41.81 |
| 0.5 | 50.61 | 62.99 | 44.93 | 70.99 | 23.09 | 39.71 | 52.73 |

| | 30° C. | | | | | | |
|---|---|---|---|---|---|---|---|
| | Atlas G5002L | Etocas 10 | | DEVTween 20 | | AgniqueAE829 | |
| | Spray- | Spray- | Spray- | Spray- | Spray- | Spray- | Spray- |
| | dried T1 | dried T1 | dried T1 | dried T1 | dried T1 | dried T1 | dried T1 |
| storage | with | without | with | without | with | without | with |
| time | lecithin | protectant | lecithin | protectant | lecithin | protectant | lecithin |
| (months) | Germination Rate (%) | | | | | | |
| 0 | 62.11 | 41.81 | 62.11 | 41.81 | 62.11 | 41.81 | 62.11 |
| 0.5 | 70.79 | 36.25 | 61.99 | 52.16 | 65.48 | 49.09 | 41.94 |

### EXAMPLE 4: VACUUM DRUM DRYING OF THE SPORE PASTE WITH AND WITHOUT LECITHIN AND GERMINATION RATE OVER TIME/SHELF LIFE STABILITY OF THE PURE SPORE POWDER

In this example we wanted to test another drying method in industrial scale. The spore suspension is rinsed onto a heated drum in a vacuum chamber (2-5 mbar) and dried on the drum surface while rotating (0.65 rpm) and harvesting the dried spore powder into a bowl by a knife scraping on the rotating drum.

TABLE 11
Trichoderma germination rates in a pilot-scale vacuum-drum-dryer (in presence and absence
of lecithin). In this study protectant-to-spore mass ratio was selected to be 1:1.

| | | | Speed | | | | | | |
|---|---|---|---|---|---|---|---|---|---|
| | Solids | | adding | | | | | Viability | Viability |
| | conc in | Process | feed | Temp | Temp | Product | Residual | before | after |
| | feed | Time | suspension | Drum | Product | output | moisture | drying | drying |
| | w % | min | g/min | ° C. | ° C. | g | % | % | % |
| Trichoderma | 7.56 | 17 | 14 | 50 | 46-40 | 13.2 | 6.88 | 98.61 | 48.0 |
| (Paste) | | | | | | | | | |
| Trichoderma | 8.28 | 12 | 14 | 50 | 42-38 | 13.0 | 11.39 | 98.61 | 68.8 |
| (Paste) + | | | | | | | | | |
| lecithin | | | | | | | | | |

The spore powders were stored in closed plastic tubes at 30° C. and the germination rate over time was studied. Lecithin showed a significant protecting effect for drying the spores, and a slight improving effect on the stability of the dried spores during storage.

TABLE 12
Germination rate over time of T1 Trichoderma spore powder
vacuum-drum-dried with and without lecithin. Storage condition is 30° C.

| storage time | Powder without | Powder with |
|---|---|---|
| (months) | lecithin | lecithin |
| 0 | 48.00 | 68.80 |
| 1 | 13.98 | 28.28 |
| 2 | 9.91 | 15.25 |

1. A composition of matter, which is
(a) a preparation comprising at least one glycerophospholipid and spores of a fungal microorganism in a weight ratio range of between 10:1 and 1:5000; or
(b) a liquid composition comprising the preparation according to (a) and at least one carrier.

2. The preparation according to claim 1(a), wherein said glycerophospholipid is selected from the group consisting of phosphatidylcholine, phosphatidylethanolamine, phosphatidylinositol, phosphatidylserine, phosphatidic acid and mixtures of any of the foregoing.

3. The preparation according to claim 1(a), wherein said weight ratio range is between 2:1 and 1:5.

4. The preparation according to claim 1(a), wherein said glycerophospholipid is a lecithin.

5. The preparation according to claim 1(a), wherein said fungal spores are of a fungal species selected from the group consisting of Trichoderma spp., Isaria spp., Beauveria spp., Paecilomyces spp., Coniothyrium spp.

6. The preparation according to claim 1(a), wherein said fungal spores are of Trichoderma spp.

7. The preparation according to claim 5, wherein said Trichoderma spp. is selected from Trichoderma harzianum, Trichoderma viride, Trichoderma atroviride, Trichoderma asperellum, Trichoderma virens, Trichoderma gamsii, Trichoderma polysporum, Trichoderma stromaticum and Trichoderma koningii.

8. The preparation according to claim 1(a), wherein said preparation does not contain vegetable oil.

9. (canceled)

10. The composition according to claim 1(b), wherein said at least one carrier is selected form the group consisting of plant oils, polyether-modified trisiloxanes, carboxylic esters and an ethoxylated and/or propoxylated organic liquid.

11. The composition according to claim 1(b), wherein said at least one carrier is Radiasurf 7403, Radiasurf 7442, Triton X 100, PEG300, triacetin, Atlas G5002 and/or Tween20.

12. The composition according to claim 1(b), further comprising a rheology-modifying agent.

13. The composition according to claim 12, wherein said rheology-modifying agent is fumed or precipitated silica, preferably Aerosil 200.

14. The composition according to claim 1(b) which is a seed treatment composition.

15. A seed coated with the liquid composition according to claim 1(b).

16. The seed according to claim 15, further comprising at least one plant protection agent.

17. The seed according to claim 16, wherein said at least one plant protection agent is selected from the group consisting of prothioconazole, metalaxyl, mefenoxam, fluoxastrobin, tebuconazole, ipconazole, metconazole, cyproconazole, epoxiconazole, propiconazole, azoxystrobin, pyraclostrobin, picoxystrobin, benzovindiflupyr, fluxapyroxad and chlorothalonil.

18. Method of
(a) producing a preparation according to claim 1(a), comprising the steps of providing non-dried fungal spores, adding at least at least one glycerophospholipid in a weight ratio of between 10:1 and 1:5000 and drying the resulting mixture; or
(b) producing a liquid composition according to claim 1(b), comprising the steps of providing non-dried fungal spores, adding at least one glycerophospholipid in a weight ratio of between 10:1 and 1:5000, drying the resulting mixture and mixing it with at least one carrier; or
c) increasing the germination rate of spores of a fungal microorganism comprising the steps of providing non-dried fungal spores, adding at least one glycerophospholipid in a weight ratio of between 10:1 and 1:5000, drying the resulting mixture and mixing it with at least one carrier; or
(d) controlling phytopathogenic fungi, insects, spiders, molluscs, weeds, rodents and/or nematodes in, on or around a plant or plant part, for enhancing growth of a plant or for increasing plant yield or root health comprising applying the composition of matter of claim 1 to said plant or plant part or to a plot where plants are to be grown; or
(e) stabilizing spores of fungal microorganisms, preferably those obtained with wet-harvest, or increasing the germination rate of spores of fungal microorganisms, the method comprising applying at least one glycerophospholipid.

19. (canceled)

20. (canceled)

21. The method of claim 18(a), wherein said drying is effected as air-drying or spray-drying or vacuum drum drying.

22. (canceled)

23. (canceled)

24. (canceled)

25. (canceled)

26. The method of claim 18(d), wherein said composition of matter is applied to seed.
